(19) United States
(12) Patent Application Publication
(10) Pub. No.: US 2015/0144563 A1
(43) Pub. Date: May 28, 2015

(54) Articles Comprising Soil Absorbing Polymers and Processes for Making Same

(71) Applicant: The Procter & Gamble Company, Cincinnati, OH (US)

(72) Inventors: Robin Lynn McKIERNAN, Mason, OH (US); Robert Joseph McCHAIN, Cincinnati, OH (US); Steven Daryl SMITH, Fairfield, OH (US)

(21) Appl. No.: 14/548,614

(22) Filed: Nov. 20, 2014

Related U.S. Application Data
(60) Provisional application No. 61/908,974, filed on Nov. 26, 2013.

(51) Int. Cl. B01J 20/28; C08F 22/38; C08G 73/02; B01J 20/24; C08F 16/06; B01J 20/26; C08F 22/10

(52) U.S. Cl. CPC B01J 20/28038; B01J 20/261; C08F 22/38; C08F 22/10; B01J 20/262; B01J 20/28033; B01J 20/24; C08F 16/06; C08G 73/0206
USPC 210/660; 442/59; 134/6; 526/317.1; 526/303.1; 528/271; 526/312; 528/422; 521/141; 521/149; 521/182; 521/50; 536/56; 536/95; 536/20; 536/102; 530/357

(57) ABSTRACT

Articles containing soil adsorbing polymers, and more particularly, articles, for example nonwovens, such as paper towels, wovens, and/or sponges and/or article-forming components thereof that comprise a durably bonded soil adsorbing polymer, article-forming components used to make such articles, and processes for making same are provided.

### FIELD OF THE INVENTION

The present invention relates to articles comprising a soil adsorbing polymer, and more particularly, to articles, for example nonwovens and/or fibrous structures, such as paper towels, wovens, and/or sponges and/or article-forming components thereof that comprise a durably bonded soil adsorbing polymer, article-forming components used to make such articles, and processes for making same.

### BACKGROUND OF THE INVENTION

Articles, such as paper towels, wipes, and/or cleaning pads, comprising soil adsorbing polymers are known in the art. However, the soil adsorbing polymers present on and/or impregnated in such known articles are not durably bonded to the articles or article-forming components making up the articles. As a result, during use of such articles by a consumer to treat a surface, such as clean the surface, the soil adsorbing polymers may become disassociated from the articles and may transfer to the surface being treated (e.g., cleaned). This may create a consumer negative such as tackiness and/or increased soiling of the surface.

One problem with such known articles is that when a soil adsorbing polymer transfers from the article to a surface being treated, the surface being treated continues to attract soil and typically retains an increased amount of soil as a result of soil adsorbing polymer being present on the treated surface.

Accordingly, there is a need for articles and/or article-forming components making up the articles to comprise durably bonded soil adsorbing polymers and processes for making same.

### SUMMARY OF THE INVENTION

The present invention fulfills the need described above by providing articles and/or article-forming components that comprise a durably bonded soil adsorbing polymer and processes for making same.

One solution to the problem described above is to durably bond soil adsorbing polymers to an article or article-forming components used to make the article.

In one example of the present invention, an article comprising a durably bonded soil adsorbing polymer as measured according to the Durably Bonded Test Method described herein is provided.

In another example of the present invention, one or more article-forming components, for example fibers, filaments, and/or particles, comprising a durably bonded soil adsorbing polymer as measured according to the Durably Bonded Test Method described herein is provided.

In another example of the present invention, a durably bonded soil adsorbing article comprising a durably bonded soil adsorbing polymer as determined by the Durably Bonded Test Method described herein such that the durably bonded soil adsorbing article exhibits an average soil adsorption value of greater than 57 mg as measured according to the Soil Adsorption Test Method described herein, is provided.

In another example of the present invention, a durably bonded soil adsorbing article comprising a soil adsorbing polymer wherein the article exhibits an average soil adsorption value of at least 25% greater than the article void of the soil adsorbing polymer as measured according to the Soil Adsorption Test Method described herein, is provided.

In another example of the present invention, a process for making a treated article, for example a durably bonded soil adsorbing article of the present invention, wherein the process comprises the steps of:
a. providing an article, for example a nonwoven, woven, and/or sponge;
b. contacting the article with a reactive monomer to prepare a reactive article comprising a monomer modified site (this step of contacting the article may optionally comprise the step of subjecting the article to a temperature of at least 30° C.); and
c. copolymerizing one or more additional monomers capable of forming a soil adsorbing polymer with the monomer modified site on the reactive article to form a treated article comprising a soil adsorbing polymer derived from the reactive monomer and the additional monomers that is durably bonded to the treated article as measured according to the Durably Bonded Test Method described herein (this step of copolymerizing may optionally comprise conducting the copolymerizing step at a temperature of at least 30° C.); and
d. optionally, washing the treated article to remove at least a portion and/or substantially all and/or all of any reactive monomer, additional monomers capable of forming a soil adsorbing polymer and/or soil adsorbing polymer that is not durably bonded to the article;
   is provided.

In another example of the present invention, a process for making a treated article, for example a durably bonded soil adsorbing article of the present invention, wherein the process comprises the steps of:
a. providing an article, for example a nonwoven, woven, and/or sponge; and
b. providing one or more reactive monomers and one or more additional monomers capable of forming a soil adsorbing polymer followed by one or more of the following steps:
   i. copolymerizing one or more of the additional monomers capable of forming a soil adsorbing polymer with one or more of the reactive monomers to form a reactive soil adsorbing polymer and then contacting the article with the reactive soil adsorbing polymer to form a treated article comprising a soil adsorbing polymer that is durably bonded to the treated article as measured according to the Durably Bonded Test Method described herein (this copolymerizing step and/or the contacting step may optionally be conducted at a temperature of at least 30° C.);
   ii. contacting the article with one or more of the reactive monomers to prepare a reactive article comprising a monomer modified site and then copolymerizing one or more of the additional monomers capable of forming a soil adsorbing polymer with the monomer modified site on the reactive article to form a treated article comprising a soil adsorbing polymer that is durably bonded to the treated article as measured according to the Durably Bonded Test Method described herein (this contacting step and/or copolymerizing step may optionally be conducted at a temperature of at least 30° C.);
   iii. concurrently contacting the article with one or more of the reactive monomers, a growing reactive soil adsorbing polymer, and/or a reactive soil adsorbing polymer to form a treated article; and copolymerizing one or more of the reactive monomers with one or more of the additional monomers capable of forming a soil adsorbing polymer such that a treated article comprising a durably bonded soil adsorbing polymer as measured according to the Durably Bonded Test Method described herein is formed (this contacting step and/or copolymerizing step may optionally be conducted at a temperature of at least 30° C.); and
c. optionally, washing the treated article to remove at least a portion and/or substantially all and/or all of any reactive monomer, additional monomers capable of forming a soil adsorbing polymer and/or soil adsorbing polymer that is not durably bonded to the article;
   is provided.

In still another example of the present invention, a process for making a treated article, for example a durably bonded soil adsorbing article of the present invention, wherein the process comprises the steps of:
a. copolymerizing one or more monomers capable of forming a soil adsorbing polymer with one or more reactive monomers to form a reactive soil adsorbing polymer (this step of copolymerizing may optionally comprise conducting the copolymerizing step at a temperature of at least about 30° C.);
b. providing an article, for example a nonwoven, woven, and/or sponge; and
c. contacting the article with the reactive soil adsorbing polymer to form a treated article comprising a soil adsorbing polymer that is durably bonded to the treated article as measured according to the Durably Bonded Test Method described herein (this step of contacting the article may optionally comprise the step of subjecting the article to a temperature of at least 30° C.); and
d. optionally, washing the treated article to remove at least a portion and/or substantially all and/or all of any reactive monomer, additional monomers capable of forming a soil adsorbing polymer and/or soil adsorbing polymer that is not durably bonded to the article;
   is provided.

In yet another example of the present invention, a process for making a treated article, for example a durably bonded soil adsorbing article of the present invention, wherein the process comprises the steps of:
a. providing an article, for example a nonwoven, woven, and/or sponge;
b. contacting the article with a free radical generating source to prepare a reactive article comprising a reactive site (this step of contacting the article may optionally comprise the step of subjecting the article to a temperature of at least 30° C.);
c. contacting the reactive article with one or more monomers capable of forming a soil adsorbing polymer (this step of contacting the article may optionally comprise the step of subjecting the article to a temperature of at least 30° C.); and
d. copolymerizing the monomers with the reactive site on the reactive article to form a treated article comprising a soil adsorbing polymer that is durably bonded to the reactive article as measured according to the Durably Bonded Test Method described herein (this step of copolymerizing may optionally comprise conducting the copolymerizing step at a temperature of at least about 30° C.); and
e. optionally, washing the treated article to remove at least a portion and/or substantially all and/or all of any reactive monomer, additional monomers capable of forming a soil adsorbing polymer and/or soil adsorbing polymer that is not durably bonded to the article;
   is provided.

In yet another example of the present invention, a process for making a treated article, for example a durably bonded soil adsorbing article of the present invention, wherein the process comprises the steps of:
a. providing an article, for example a nonwoven, woven, and/or sponge, for example a non-lotioned article;
b. plasma and/or corona treating the article to prepare a reactive article comprising a reactive site;
c. contacting the reactive article with one or more monomers capable of forming a soil adsorbing polymer (this step of contacting the article may optionally comprise the step of subjecting the article to a temperature of at least 30° C.); and
d. copolymerizing the monomers with the reactive site on the reactive article to form a treated article comprising a soil adsorbing polymer that is durably bonded to the reactive article as measured according to the Durably Bonded Test Method described herein (this step of copolymerizing may optionally comprise conducting the copolymerizing step at a temperature of at least about 30° C.); and
e. optionally, washing the treated article to remove at least a portion and/or substantially all and/or all of any reactive monomer, additional monomers capable of forming a soil adsorbing polymer and/or soil adsorbing polymer that is not durably bonded to the article;
   is provided.

In yet another example of the present invention, a process for making a treated article, for example a durably bonded soil adsorbing article of the present invention, wherein the process comprises the steps of:
a. providing an article, for example a nonwoven, woven, and/or sponge, for example a polyolefin-based nonwoven, and/or article-forming components, for example polyolefin-based filaments and optionally, solid additives, for example pulp, that are used to make a nonwoven, for example a coform nonwoven;
b. copolymerizing one or more monomers capable of forming a soil adsorbing polymer in the presence of the article and/or article forming components during the article making process to form a treated article such that the treated article is a durably bonded soil adsorbing article as measured according to the Durably Bonded Test Method described herein (this step of copolymerizing may optionally comprise conducting the copolymerizing step at a temperature of at least about 30° C.);
c. optionally, crosslinking the soil adsorbing polymer to itself entrapping portions of the article in the crosslinked soil adsorbing polymer matrix; and
d. optionally, washing the treated article to remove at least a portion and/or substantially all and/or all of any monomers capable of forming a soil adsorbing polymer and/or soil adsorbing polymer that is not durably bonded to the article as measured according to the Durably Bonded Test Method described herein;
   is provided.

In yet another example of the present invention, a process for making a treated article, for example a durably bonded soil adsorbing article of the present invention, wherein the process comprises the steps of:
a. providing an article, for example a nonwoven, woven, and/or sponge, for example a polyolefin-based nonwoven, and/or article-forming components, for example polyolefin-based filaments and optionally, solid additives, for example pulp, that are used to make a nonwoven, for example a coform nonwoven;
b. copolymerizing one or more monomers capable of forming a soil adsorbing polymer to form the soil adsorbing polymer;
c. exposing the article and/or article forming components to the soil adsorbing polymer; and
d. crosslinking the soil adsorbing polymer to itself entrapping portions of the article and/or article-forming components in the crosslinked soil adsorbing polymer matrix to form a treated article and/or treated article-forming components such that the crosslinked soil adsorbing polymer matrix is durably bonded to the treated article and/or treated article-forming components as measured according to the Durably Bonded Test Method described herein;
e. optionally, washing the treated article to remove at least a portion and/or substantially all and/or all of any monomers capable of forming a soil adsorbing polymer and/or soil adsorbing polymer that is not durably bonded to the article as measured according to the Durably Bonded Test Method described herein;
   is provided.

In even another example of the present invention, a process for making a treated article-forming component of the present invention, wherein the process comprises the steps of:
a. providing one or more article-forming components, for example pulp fibers;
b. contacting at least one of the article-forming components with a reactive monomer to prepare at least one reactive article-forming component comprising a monomer modified site (this step of contacting the article-forming components may optionally comprise the step of subjecting the article-forming components to a temperature of at least 30° C.); and
c. copolymerizing one or more additional monomers capable of forming a soil adsorbing polymer with the monomer modified site on the reactive article-forming component to form a treated article-forming component comprising a soil adsorbing polymer derived from the reactive monomer and the additional monomers that is durably bonded to the treated article-forming component as measured according to the Durably Bonded Test Method described herein (this step of copolymerizing may optionally comprise conducting the copolymerizing step at a temperature of at least 30° C.); and
d. optionally, washing the treated article-forming component to remove at least a portion and/or substantially all and/or all of any reactive monomer, additional monomers capable of forming a soil adsorbing polymer and/or soil adsorbing polymer that is not durably bonded to the article; and
e. optionally, associating a plurality of treated article-forming components to form a treated article comprising a soil adsorbing polymer that is durably bonded to the article as measured according to the Durably Bonded Test Method; and
f. optionally, washing the treated article to remove at least a portion and/or substantially all and/or all of any reactive monomer, additional monomers capable of forming a soil adsorbing polymer and/or soil adsorbing polymer that is not durably bonded to the article;
   is provided.

In another example of the present invention, a process for making a treated article-forming component of the present invention, wherein the process comprises the steps of:
a. providing one or more article-forming components, for example pulp fibers; and
b. providing one or more reactive monomers and one or more additional monomers capable of forming a soil adsorbing polymer followed by one or more of the following steps:
   i. copolymerizing one or more of the additional monomers capable of forming a soil adsorbing polymer with one or more of the reactive monomers to form a reactive soil adsorbing polymer and then contacting the one or more article-forming components with the reactive soil adsorbing polymer to form a treated article-forming component comprising a soil adsorbing polymer that is durably bonded to the treated article-forming component as measured according to the Durably Bonded Test Method described herein (this copolymerizing step and/or the contacting step may optionally be conducted at a temperature of at least 30° C.);
   ii. contacting the one or more article-forming components with one or more of the reactive monomers to prepare a reactive article comprising a monomer modified site and then copolymerizing one or more of the additional monomers capable of forming a soil adsorbing polymer with the monomer modified site on the reactive article to form a treated article-forming component comprising a soil adsorbing polymer that is durably bonded to the treated article-forming component as measured according to the Durably Bonded Test Method described herein (this contacting step and/or copolymerizing step may optionally be conducted at a temperature of at least 30° C.);
   iii. concurrently contacting the one or more article-forming components with one or more of the reactive monomers, a growing reactive soil adsorbing polymer, and/or a reactive soil adsorbing polymer to form a treated article-forming component; and copolymerizing one or more of the reactive monomers with one or more of the additional monomers capable of forming a soil adsorbing polymer such that a treated article-forming component comprising a durably bonded soil adsorbing polymer as measured according to the Durably Bonded Test Method described herein is formed (this contacting step and/or copolymerizing step may optionally be conducted at a temperature of at least 30° C.); and
c. optionally, washing the treated article-forming component to remove at least a portion and/or substantially all and/or all of any reactive monomer, additional monomers capable of forming a soil adsorbing polymer and/or soil adsorbing polymer that is not durably bonded to the article-forming component;
d. optionally, associating a plurality of treated article-forming components to form a treated article comprising a soil adsorbing polymer that is durably bonded to the treated article as measured according to the Durably Bonded Test Method, described herein.
   is provided.

In even yet another example of the present invention, a process for making a treated article-forming component of the present invention, wherein the process comprises the steps of:
a. copolymerizing one or more monomers capable of forming a soil adsorbing polymer with one or more reactive monomers to form a reactive soil adsorbing polymer (this step of copolymerizing may optionally comprise conducting the copolymerizing step at a temperature of at least about 30° C.);
b. providing one or more article-forming components, for example pulp fibers; and
c. contacting at least one of the article-forming components with the reactive soil adsorbing polymer to form a treated article-forming component comprising a soil adsorbing polymer that is durably bonded to the treated article-forming component as measured according to the Durably Bonded Test Method described herein (this step of contacting the article may optionally comprise the step of subjecting the article to a temperature of at least 30° C.); and
d. optionally, washing the treated article-forming component to remove at least a portion and/or substantially all and/or all of any reactive monomer, additional monomers capable of forming a soil adsorbing polymer and/or soil adsorbing polymer that is not durably bonded to the article; and
e. optionally, associating a plurality of treated article-forming components to form a treated article comprising a soil adsorbing polymer that is durably bonded to the article as measured according to the Durably Bonded Test Method; and
f. optionally, washing the treated article to remove at least a portion and/or substantially all and/or all of any reactive monomer, additional monomers capable of forming a soil adsorbing polymer and/or soil adsorbing polymer that is not durably bonded to the article;
   is provided.

In even still yet another example of the present invention, a process for making a treated article-forming component of the present invention, wherein the process comprises the steps of:
a. providing one or more article-forming components, for example pulp fibers;
b. contacting at least one of the article-forming components with a free radical generating source to prepare a reactive article-forming component comprising a reactive site (this step of contacting the article may optionally comprise the step of subjecting the article to a temperature of at least 30° C.);
c. contacting the reactive article-forming component with one or more monomers capable of forming a soil adsorbing polymer (this step of contacting the article may optionally comprise the step of subjecting the article to a temperature of at least 30° C.); and
d. copolymerizing the monomers with the reactive site on the reactive article-forming component to form a treated article-forming component comprising a soil adsorbing polymer that is durably bonded to the reactive article-forming component as measured according to the Durably Bonded Test Method described herein (this step of copolymerizing may optionally comprise conducting the copolymerizing step at a temperature of at least about 30° C.); and
e. optionally, washing the treated article-forming component to remove at least a portion and/or substantially all and/or all of any reactive monomer, additional monomers capable of forming a soil adsorbing polymer and/or soil adsorbing polymer that is not durably bonded to the article; and
f. optionally, associating a plurality of treated article-forming components to form a treated article comprising a soil adsorbing polymer that is durably bonded to the article as measured according to the Durably Bonded Test Method; and
g. optionally, washing the treated article to remove at least a portion and/or substantially all and/or all of any reactive monomer, additional monomers capable of forming a soil adsorbing polymer and/or soil adsorbing polymer that is not durably bonded to the article;
   is provided.

In yet another example of the present invention, a process for making a treated article-forming component of the present invention, wherein the process comprises the steps of:
a. providing one or more article-forming components, for example pulp fibers;
b. plasma and/or corona treating at least one of the article-forming components to prepare a reactive article-forming component comprising a reactive site;
c. contacting the reactive article-forming component with one or more monomers capable of forming a soil adsorbing polymer (this step of contacting the article may optionally comprise the step of subjecting the article-forming component to a temperature of at least 30° C.); and
d. copolymerizing the monomers with the reactive site on the reactive article-forming component to form a treated article-forming component comprising a soil adsorbing polymer that is durably bonded to the reactive article-forming component as measured according to the Durably Bonded Test Method described herein (this step of copolymerizing may optionally comprise conducting the copolymerizing step at a temperature of at least about 30° C.); and
e. optionally, washing the treated article-forming component to remove at least a portion and/or substantially all and/or all of any reactive monomer, additional monomers capable of forming a soil adsorbing polymer and/or soil adsorbing polymer that is not durably bonded to the article-forming component;
   is provided.

In yet another example of the present invention, a process for making a treated article-forming component of the present invention, wherein the process comprises the steps of:
a. providing one or more article-forming components, for example pulp fibers;
b. copolymerizing one or more monomers capable of forming a soil adsorbing polymer in the presence of at least one of the article-forming components such that the soil adsorbing polymer is durably bonded to the article-forming component as measured according to the Durably Bonded Test Method described herein (this step of copolymerizing may optionally comprise conducting the copolymerizing step at a temperature of at least about 30° C.);
c. optionally, crosslinking the soil adsorbing polymer to itself entrapping portions of the article-forming component in the crosslinked soil adsorbing polymer matrix; and
d. optionally, washing the treated article-forming component to remove at least a portion and/or substantially all and/or all of any monomers capable of forming a soil adsorbing polymer and/or soil adsorbing polymer that is not durably bonded to the article-forming component as measured according to the Durably Bonded Test Method described herein;
   is provided.

In yet another example of the present invention, a process for making a treated article-forming component of the present invention, wherein the process comprises the steps of:
a. providing one or more article-forming components, for example pulp fibers;
b. copolymerizing one or more monomers capable of forming a soil adsorbing polymer to form the soil adsorbing polymer;
c. exposing at least one of the article forming components to the soil adsorbing polymer; and
d. crosslinking the soil adsorbing polymer to itself entrapping portions of the article-forming component in the crosslinked soil adsorbing polymer matrix to form a treated article-forming component such that the crosslinked soil adsorbing polymer matrix is durably bonded to the treated article-forming component as measured according to the Durably Bonded Test Method described herein;
e. optionally, washing the treated article-forming component to remove at least a portion and/or substantially all and/or all of any monomers capable of forming a soil adsorbing polymer and/or soil adsorbing polymer that is not durably bonded to the article-forming component as measured according to the Durably Bonded Test Method described herein;
   is provided.

The articles formed from associating one or more of the treated article-forming components may comprise 100% by weight of the treated article-forming components. In another example, the articles formed from associating one or more of the treated article-forming components may comprise less than 100% by weight of the treated article-forming components, in other words, may comprise a blend or mixture of treated article-forming components, such as pulp fibers comprising a soil adsorbing polymer, and article-forming components, such as pulp fibers, that do not comprise a soil adsorbing polymer.

In even yet another example of the present invention, a method for treating a surface, such as cleaning a surface, comprising the step of contacting the surface (hard surface—countertops, floors, mirrors, stovetops, bathroom surfaces, appliances, soft surface—upholstery, carpets, curtains, clothing, fugitive cloth for laundry, body surface—skin (makeup removal), hair, baby bottoms, teeth, such as plaque removing wipes, pet hair, pet teeth, “pet care” etc.) (article is moist or surface is moist—enough moisture to “activate” polymer) with an article comprising a durably bonded soil adsorbing polymer of the present invention as measured according to the Durably Bonded Test Method described herein is provided.

In even still another example of the present invention, a method for treating a surface, such as cleaning a surface, comprising the step of contacting the surface with a durably bonded soil adsorbing article of the present invention, optionally in the presence of moisture (either present on the surface or present on the durably bonded soil adsorbing article), is provided.

In even still another example of the present invention, a method for treating a surface, such as cleaning a surface, comprises the step of contacting the surface with one or more durably bonded soil adsorbing article-forming components, optionally in the presence of moisture (either present on the surface or present on the durably bonded soil adsorbing article), is provided.

In still another example of the present invention, a method for treating a fluid, such as air, water and/or oil, such as cleaning and/or filtering particulates and/or soil and/or contaminants from the fluid, comprising the step of contacting the fluid with a durably bonded soil adsorbing article, is provided.

In another example of the present invention, a method for treating a fluid, such as air, water and/or oil, such as cleaning and/or filtering particulates and/or soil and/or contaminants from the fluid, comprising the step of contacting the fluid with one or more durably bonded article-forming components, is provided.

Accordingly, the present invention provides articles and/or article-forming components comprising a durably bonded soil adsorbing polymer, process for making such articles and/or article-forming components, and methods for cleaning using such articles and/or article-forming components.

### DETAILED DESCRIPTION OF THE INVENTION

### Definitions

“Article” as used herein means any solid matter, any liquid, such as an emulsion, containing solid matter and/or a film. Non-limiting examples of articles of the present invention include webs, wipes, wet wipes, sponges including loofah sponges, foam structures, co-form materials, cotton pads, cotton combs, cotton swabs, dissolvable open cell foam, bar soap, laundry bars, laundry sheets, toothpastes, toothbrushes, floss, chewing gum, tooth strips, mops, liquid shampoos, liquid conditioners, mouthwashes, denture cleaning products. The liquid articles of the present invention include at least pieces and/or portions of solid matter, for example portions of webs. In one example, the article is a dry article. In one example, at least a portion of the article exhibits a basis weight of about 500 gsm or less, and/or about 300 gsm or less and/or about 150 gsm or less and/or about 100 gsm or less and/or to about 20 gsm and/or to about 30 gsm and/or to about 95 gsm. In yet another example, the article is a consumer goods article.

In one example, the article is selected from the group consisting of: towels, dryer sheets, filter media, wipes, sponges, mops, cleaning implements, door mats, car mats, disposable cloths, laundry sheets, paper towels, absorbent cores, scrubbing pads, brushes, facial tissue, dusters, and French press.

“Article-forming component” as used herein means a component that when combined with one or more other article-forming components forms an article. Non-limiting examples of article-forming components include fibers, filaments, and/or particles. In one example, one or more discrete article-forming components may be used as an article of the present invention without combining the one or more discrete article-forming components to form an article. For example, one or more article-forming components may be added to a liquid composition to form a liquid article of the present invention.

“Web” as used herein means a fibrous structure or a film.

“Fibrous structure” as used herein means a structure that comprises one or more fibrous filaments and/or fibers. In one example, a fibrous structure according to the present invention means an orderly arrangement of filaments and/or fibers within a structure in order to perform a function. In one example, a fibrous structure comprises inter-entangled filaments. Non-limiting examples of fibrous structures of the present invention include paper, fabrics (including woven, knitted, and non-woven), absorbent pads (for example for diapers or feminine hygiene products), cotton pads, and wipes.

Non-limiting examples of processes for making fibrous structures include known wet-laid processes, such as wet-laid papermaking processes, and air-laid processes, such as air-laid papermaking processes, meltblowing processes, spunbonding processes, solution spinning processes and other spinning processes. Wet-laid and/or air-laid papermaking processes and/or air-laid papermaking processes typically include a step of preparing a composition comprising a plurality of fibers that are suspended in a medium, either wet, more specifically aqueous medium, or dry, more specifically gaseous medium, such as air. The aqueous medium used for wet-laid processes is oftentimes referred to as a fiber slurry. The fiber composition is then used to deposit a plurality of fibers onto a forming wire or belt such that an embryonic fibrous structure is formed, after which drying and/or bonding the fibers together results in a fibrous structure. Further processing the fibrous structure may be carried out such that a finished fibrous structure is formed. For example, in typical papermaking processes, the finished fibrous structure is the fibrous structure that is wound on the reel at the end of papermaking, and may subsequently be converted into a finished product, e.g. a sanitary tissue product.

“Fiber” and/or “Filament” as used herein means an elongate particulate having an apparent length greatly exceeding its apparent width, i.e. a length to diameter ratio of at least about 10. In one example, a “fiber” is an elongate particulate as described above that exhibits a length of less than 5.08 cm (2 in.) and a “filament” is an elongate particulate as described above that exhibits a length of greater than or equal to 5.08 cm (2 in.).

Fibers are typically considered discontinuous in nature. Non-limiting examples of fibers include wood pulp fibers and synthetic staple fibers such as polyester fibers.

Filaments are typically considered continuous or substantially continuous in nature. Filaments are relatively longer than fibers. Non-limiting examples of filaments include meltblown and/or spunbond filaments. Non-limiting examples of polymers, such as hydroxyl polymers, that can be spun into filaments include natural polymers, such as starch, starch derivatives, cellulose and cellulose derivatives, hemicellulose, hemicellulose derivatives, keratin, and synthetic polymers including, but not limited to polyvinyl alcohol filaments and/or polyvinyl alcohol derivative filaments, and thermoplastic polymer filaments, such as polyesters, nylons, polyolefins such as polypropylene filaments, polyethylene filaments, and biodegradable or compostable thermoplastic fibers such as polylactic acid filaments, polyhydroxyalkanoate filaments and polycaprolactone filaments. The filaments may be monocomponent or multicomponent, such as bicomponent filaments.

In one example, the article, for example a fibrous structure of the present invention comprises a hydroxyl polymer. For example, one or more filaments making up the fibrous structure may comprise a hydroxyl polymer, such as a hydroxyl polymer selected from the group consisting of: polyvinyl alcohol, cellulose, carboxymethylcellulose, chitin, chitosan, starch, starch derivatives, keratin, and mixtures thereof.

In one example, the article, for example a fibrous structure of the present invention comprises an amine moiety, such as a primary, secondary, and/or tertiary amine.

In one example of the present invention, “fiber” refers to papermaking fibers. Papermaking fibers useful in the present invention include cellulosic fibers commonly known as wood pulp fibers. Applicable wood pulps include chemical pulps, such as Kraft, sulfite, and sulfate pulps, as well as mechanical pulps including, for example, groundwood, thermomechanical pulp and chemically modified thermomechanical pulp. Chemical pulps, however, may be preferred since they impart a superior tactile sense of softness to tissue sheets made therefrom. Pulps derived from both deciduous trees (hereinafter, also referred to as “hardwood”) and coniferous trees (hereinafter, also referred to as “softwood”) may be utilized. The hardwood and softwood fibers can be blended, or alternatively, can be deposited in layers to provide a stratified web. Also applicable to the present invention are fibers derived from recycled paper, which may contain any or all of the above categories as well as other non-fibrous materials such as fillers and adhesives used to facilitate the original papermaking.

In addition to the various wood pulp fibers, other cellulosic fibers such as cotton linters, rayon, lyocell, trichomes, and bagasse can be used in this invention. Other sources of cellulose in the form of fibers or capable of being spun into fibers include grasses and grain sources.

In one example, the fibrous structure of the present invention may comprise filaments, such as polypropylene filaments, and fibers, such as pulp fibers, such as a co-formed fibrous structure. The pulp fibers may be the article-forming components that comprise a durably bonded soil adsorbing polymer.

“Dry article” as used herein means an article that comprises less than 30% and/or less than 20% and/or less than 15% and/or less than 10% and/or less than 7% and/or less than 5% and/or less than 3% and/or less than 2% and/or less than 1% and/or less than 0.5% by weight of water (moisture) as measured according to the Water Content Test Method described herein.

“Dry web” as used herein means a web that comprises less than 30% and/or less than 20% and/or less than 15% and/or less than 10% and/or less than 7% and/or less than 5% and/or less than 3% and/or less than 2% and/or less than 1% and/or less than 0.5% by weight of water (moisture) as measured according to the Water Content Test Method described herein.

“Dry fibrous structure” as used herein means a fibrous structure that comprises less than 30% and/or less than 20% and/or less than 15% and/or less than 10% and/or less than 7% and/or less than 5% and/or less than 3% and/or less than 2% and/or less than 1% and/or less than 0.5% by weight of water (moisture) as measured according to the Water Content Test Method described herein.

“Sanitary tissue product” as used herein means a soft, low density (i.e. <about 0.15 g/cm³) web useful as a wiping implement for post-urinary and post-bowel movement cleaning (toilet tissue), for otorhinolaryngological discharges (facial tissue), multi-functional absorbent and cleaning uses (absorbent towels), and folded sanitary tissue products such as napkins and/or facial tissues including folded sanitary tissue products dispensed from a container, such as a box. The sanitary tissue product may be convolutedly wound upon itself about a core or without a core to form a sanitary tissue product roll.

In one example, the sanitary tissue product of the present invention comprises a fibrous structure according to the present invention.

The sanitary tissue products of the present invention may exhibit a basis weight between about 10 g/m² to about 120 g/m² and/or from about 15 g/m² to about 110 g/m² and/or from about 20 g/m² to about 100 g/m² and/or from about 30 to 90 g/m². In addition, the sanitary tissue product of the present invention may exhibit a basis weight between about 40 g/m² to about 120 g/m² and/or from about 50 g/m² to about 110 g/m² and/or from about 55 g/m² to about 105 g/m² and/or from about 60 to 100 g/m².

The sanitary tissue products of the present invention may exhibit a density (measured at 95 g/in²) of less than about 0.60 g/cm³ and/or less than about 0.30 g/cm³ and/or less than about 0.20 g/cm³ and/or less than about 0.10 g/cm³ and/or less than about 0.07 g/cm³ and/or less than about 0.05 g/cm³ and/or from about 0.01 g/cm³ to about 0.20 g/cm³ and/or from about 0.02 g/cm³ to about 0.10 g/cm³.

The sanitary tissue products of the present invention may be in the form of sanitary tissue product rolls. Such sanitary tissue product rolls may comprise a plurality of connected, but perforated sheets of fibrous structure, that are separably dispensable from adjacent sheets. In one example, one or more ends of the roll of sanitary tissue product may comprise an adhesive and/or dry strength agent to mitigate the loss of fibers, especially wood pulp fibers from the ends of the roll of sanitary tissue product.

The sanitary tissue products of the present invention may comprises additives such as softening agents, temporary wet strength agents, permanent wet strength agents, bulk softening agents, lotions, silicones, wetting agents, latexes, especially surface-pattern-applied latexes, dry strength agents such as carboxymethylcellulose and starch, and other types of additives suitable for inclusion in and/or on sanitary tissue products.

“Film” refers to a sheet-like material wherein the length and width of the material far exceed the thickness of the material.

“Durably bonded soil adsorbing article” (or “durably bonded soil adsorbing article-forming component”) as used herein means an article (or article-forming component) comprising a soil adsorbing polymer that is retained by the article (or article-forming component) after being subjected to the Durably Bonded Test Method described herein. In one example, the durably bonded soil adsorbing article exhibits an average soil adsorption value of greater than 57 mg and/or greater than 60 mg and/or greater than 75 mg and/or greater than 90 mg and/or greater than 100 mg and/or greater than 110 mg and/or greater than 130 mg as measured by the Soil Adsorption Test Method described herein. In another example, the durably bonded soil adsorbing article exhibits an average soil adsorption value of at least 25% and/or at least 30% and/or at least 40% and/or at least 50% greater than the article void of the soil adsorbing polymer as measured according to the Soil Adsorption Test Method described herein.

“Durably bonded soil adsorbing polymer” as used herein means a soil adsorbing polymer that is associated with an article such that the soil adsorbing polymer remains associated with the article after being subjected to Durably Bonded Test Method described herein.

“Associated” as used herein with reference to a soil adsorbing polymer being associated with an article means that the soil adsorbing polymer is covalently bound to a portion of the article, such as grafted to a portion of the article (or article-forming component), and/or is entangled within the article.

“Hard surface” refers to any surface of a non-supple material. Non-limiting examples of hard surfaces are typically found in and around houses like bathrooms, kitchens, basements and garages, e.g., floors, walls, tiles, windows, countertops, sinks, showers, shower doors, wash basins, dishes, bath fixtures, kitchen fixtures, appliances, toilets, bath tubs, teeth, mirrors, glass surfaces, wood surfaces, tiles, linoleum, automotive surfaces (interior and exterior), windshields, furniture, laminates, granite, synthetic solid surfaces, such as Conan by DuPont, and fittings and the like made of different materials like ceramic, enamel, painted and un-painted concrete, plaster, bricks, vinyl, no-wax vinyl, linoleum, melamine, Formica®, glass, any plastics, metals, chromed surface and the like. The term “hard surface” as used herein also includes household appliances including, but not limited to, washing machines, automatic dryers, refrigerators, freezers, ovens, microwave ovens, dishwashers and the like.

“Soft surfaces” as used herein means any surface of a supple material. Non-limiting examples of soft surfaces include fabric, upholstery, furniture, pets, carpet, drapes, rugs, shower curtains, clothing, shoes, mattresses, bedding, hair, skin, plants, children's toys, and the like.

“Hydrophilic” as used herein means a surface is wettable by aqueous fluids deposited thereon. Hydrophilicity and wettability are typically defined in terms of contact angle and the surface tension of the fluids and surfaces involved. This is discussed in detail in the American Chemical Society publication entitled Contact Angle, Wettability and Adhesion, edited by Robert F. Gould (Copyright 1964) which is hereby incorporated by reference. A surface is said to be wetted by an aqueous fluid (hydrophilic) when the fluid tends to spread spontaneously across the surface. Conversely, a surface is considered to be “hydrophobic” if the aqueous fluid does not tend to spread spontaneously across the surface.

In one example, “hydrophilic” and “hydrophobic” have meanings well established in the art with respect to the contact angle of a drop of water on the surface of a material. Thus, a material having a contact angle of greater than 90° is considered hydrophobic, and a material having a contact angle of 90° or less is considered hydrophilic. Absolute values of hydrophobicity/hydrophilicity are not generally important, but relative values are.

“Soil” refers to organic or inorganic material, often particulate in nature that may include dirt, clays, food particulates, or greasy residue, soot, etc.

“Basis Weight” as used herein is the weight per unit area of a sample reported in lbs/3000 ft² or g/m² and is measured according to the Basis Weight Test Method described herein.

“By weight of water” or “water content” or “by weight of moisture” or “moisture content” means the amount of water (moisture) present in an article measured according to the Water Content Test Method described herein immediately after the article has been conditioned in a conditioned room at a temperature of 73° F.±4° F. (about 23° C.±2° C.) and a relative humidity of 50%±10% for 2 hours.

“Machine Direction” or “MD” as used herein means the direction parallel to the flow of The fibrous structure through The fibrous structure making machine and/or sanitary tissue product manufacturing equipment.

“Cross Machine Direction” or “CD” as used herein means the direction parallel to the width of The fibrous structure making machine and/or sanitary tissue product manufacturing equipment and perpendicular to the machine direction.

“Ply” as used herein means an individual, integral fibrous structure.

“Plies” as used herein means two or more individual, integral fibrous structures disposed in a substantially contiguous, face-to-face relationship with one another, forming a multi-ply fibrous structure and/or multi-ply sanitary tissue product. It is also contemplated that an individual, integral fibrous structure can effectively form a multi-ply fibrous structure, for example, by being folded on itself.

“Monomeric unit” as used herein is a constituent unit (sometimes referred to as a structural unit) of a polymer.

“Hydrophilic monomeric unit” or “hydrophilic unit” as used herein with reference to monomeric units means a monomeric unit that enhances the affinity of the polymer towards water. Typical hydrophilic monomeric units comprise functional groups such as polar and/or charged functional groups. Non-limiting examples of such functional groups include acid groups in their free acid and salt forms, ether groups, amine functionalized groups, quaternary ammonium groups, alcoholic groups, and combinations thereof. In one example, a polymer comprising one or more hydrophilic monomeric units may exhibit a smaller contact angle than the same polymer without the hydrophilic monomeric units.

“Nonionic monomeric unit” as used herein means a monomeric unit that exhibits no net charge at a pH of 7 and/or is identified as a nonionic monomeric unit herein. A nonionic monomeric unit may be derived from a nonionic monomer.

“Nonionic monomer” as used herein means a monomer that exhibits no net charge at a pH of 7 and/or is identified as a nonionic monomer herein.

“Anionic monomeric unit” as used herein means a monomeric unit that exhibits a net negative charge at a pH of 7 and/or is identified as an anionic monomeric unit herein. An anionic monomeric unit may be derived from an anionic monomer. An anionic monomeric unit is generally associated with one or more protons or cations such as cations of alkali metal or alkaline earth metal, for example sodium or cationic groups such as ammonium.

“Anionic monomer” as used herein means a monomer that exhibits a net negative charge at a pH of 7 and/or is identified as an anionic monomer herein. An anionic monomer is generally associated with one or more cations such as protons or cations of alkali metal or alkaline earth metal, for example sodium or cationic groups such as ammonium.

“Cationic monomeric unit” as used herein means a monomeric unit that exhibits a net positive charge at a pH of 7 and/or is identified as a cationic monomeric unit herein. A cationic monomeric unit may be derived from a cationic monomer. A cationic monomeric unit is generally associated with one or more anions such as a chloride ion, a bromide ion, a sulfonate group and/or a methyl sulfate group.

“Cationic monomer” as used herein means a monomer that exhibits a net positive charge at a pH of 7 and/or is identified as a cationic monomer herein. A cationic monomer is generally associated with one or more anions such as a chloride ion, a bromide ion, a sulfonate group and/or a methyl sulfate group.

“Zwitterionic monomeric unit” as used herein means a monomeric unit that exhibits both a negative charge and a positive charge on the same monomeric unit at a pH of 7 and/or is identified as a zwitterionic monomeric unit herein. A zwitterionic monomeric unit may be derived from a zwitterionic monomer. A zwitterionic monomeric unit is generally associated with one or more protons or cations such as cations of alkali metal or alkaline earth metal, for example sodium or cationic groups such as ammonium and one or more anions such as a chloride ion, a bromide ion, a sulfonate group and/or a methyl sulfate group.

“Zwitterionic monomer” as used herein means a monomer that exhibits both a negative charge and a positive charge on the same monomer at a pH of 7 and/or is identified as a zwitterionic monomeric unit herein. A zwitterionic monomer is generally associated with one or more protons or cations such as cations of alkali metal or alkaline earth metal, for example sodium or cationic groups such as ammonium and one or more anions such as a chloride ion, a bromide ion, a sulfonate group and/or a methyl sulfate group.

For clarity purposes, the total “% wt” values do not exceed 100% wt.

### Article

The article of the present invention comprises a durably bonded soil adsorbing polymer as measured according to the Durably Bonded Test Method described herein.

The article may be in the form of a wet article or a dry article or a combination wet and dry article. The article may be designed to be used wet and/or dry.

In one example, the article comprises a web. In another example, the article comprises a nonwoven material such as a paper towel, napkins, a dryer sheet, a laundry sheet, a filter medium, a wipe, a toilet tissue, a facial tissue, surgical gowns, and face masks. In still another example, the article comprises a woven material such as a towel, wash cloths, garments, sports apparel, and gloves. In another example, the article comprises a particle, such as carpet cleaner powder and hard surface cleaner powder. In even other examples, the article of the present invention is disposable. In still another example, the article of the present invention comprises sponges, mops, cleaning implements such as cleaning pads, for example Swifter® cleaning pads, door mats, car mats, disposable cloths, absorbent cores for use in various absorbent products such as diapers and feminine hygiene products, scrubbing pads, brushes, and dusters such as Swifter® dusters.

When the article comprises a web, the web may comprise a fibrous structure. The fibrous structure may be a dry fibrous structure.

The fibrous structure of the present invention may comprise a plurality of pulp fibers, such as wood pulp fibers. Further, the fibrous structure of the present invention may comprise a single-ply or multi-ply sanitary tissue product, such as a paper towel.

In still another example, the fibrous structure of the present invention may comprise a plurality of filaments. The filaments may be inter-entangled to form the fibrous structure.

In even still another example, the fibrous structure of the present invention may comprise a plurality of filaments and a plurality of fibers, for example wood pulp fibers.

In another example, the article of the present invention may comprise a web, for example a fibrous structure, in the form of a cleaning pad suitable for use with a cleaning device, such as a floor cleaning device, for example a Swiffer® cleaning pad or equivalent cleaning pads.

In still another example, the article of the present invention may comprise a foam structure.

The article of the present invention may be used to clean various surfaces, both hard and/or soft surfaces. Non-limiting examples of hard surfaces include kitchen countertops, appliances, dishes, pots, pans, sinks, floors, tables, outdoor furniture, cars, trucks, windows, mirrors, blinds, fans, lamps, lights, televisions, tile, glass, linoleum, tires, wheels, rims, metal surfaces, concrete surfaces, laminates, paintings, photographs, banisters, doors, eyeglasses, bathroom surfaces including toilet, toilet bowls, showers, teeth, and tubs, and the like. Non-limiting examples of soft surfaces include fabric, upholstery, furniture, pets, carpet, drapes, rugs, clothing, shoes, mattresses, bedding, hair, skin, plants, children's toys, and the like.

The article of the present invention may be used alone or in combination with other components, such as a liquid, to clean the surfaces to be cleaned.

The article of the present invention comprises a soil adsorbing polymer. The soil adsorbing polymer may be present in and/or on the article at a level of greater than 0% and/or greater than 0.005% and/or greater than 0.01% and/or greater than 0.05% and/or greater than 0.1% and/or greater than 0.15% and/or greater than 0.2% and/or to about 70% and/or less than 50% and/or less than 25% and/or less than 24% and/or less than 20% and/or less than 14% and/or less than 6% and/or less than 5% and/or less than 2% and/or less than 1% and/or less than 0.6% by weight of the article. In one example, the soil adsorbing polymer is present in and/or on the article at a level of from about 0.005% to about 0.1% and/or from about 0.005% to about 0.05% by weight of the article.

The article may comprise other ingredients in addition to the soil adsorbing polymer, for example a surfactant. The surfactant may be present in the article at a level of from about 0.01% to about 0.5% by weight of the article. Non-limiting examples of a suitable surfactant include C₈₋₁₆ alkyl polyglucoside, cocoamido propyl sulfobetaine or mixtures thereof.

In one example, the article comprises a signal, such as a dye and/or pigment that becomes visible or becomes invisible to a consumer's eye when the article adsorbs soil and/or when a soil adsorbing polymer present in and/or on the article adsorbs soil. In another example, the signal may be a difference in texture of the article or a difference in the physical state of the article.

In another example, the soil adsorbing polymer may be present in and/or on an article in a pattern, such as a non-random repeating pattern composing lines and or letters/words, and/or present in and/or on regions of different density, different basis weight, different elevation and/or different texture of the article.

### Soil Adsorbing Polymers

The soil adsorbing polymers of the present invention comprise one or more soil adsorbing polymer monomeric units that are derived from corresponding monomers capable of forming a soil adsorbing polymer.

In one example, the soil adsorbing polymer may be durably bonded to an article and/or article-forming component of the present invention through a reactive monomeric unit bonded to the article and/or article-forming component by copolymerizing one or more monomers capable of forming a soil adsorbing polymer with the reactive monomeric unit bonded to the article and/or article-forming component.

In another example, the soil adsorbing polymer may be durably bonded to an article and/or article-forming component of the present invention directly to a reactive site of the article and/or article-forming component formed by a free radical generating source by copolymerizing one or more monomers capable of forming a soil adsorbing polymer with the reactive site of the article and/or article-forming component.

In yet another example, the soil adsorbing polymer may be durably bonded to an article and/or article-forming component by contacting the article and/or article-forming component with a reactive soil adsorbing polymer formed by copolymerizing one or more monomers capable of forming a soil adsorbing polymer with one or more reactive monomers. The resulting reactive soil adsorbing polymer comprises one or more soil adsorbing polymer monomeric units and one or more reactive monomeric units.

In one example, the soil adsorbing polymer may be crosslinked to itself with a suitable crosslinking agent. Non-limiting examples of suitable crosslinking agents include bi- or polyfunctional vinyl monomers including by way of illustration and not limitation, allyl methacrylate; triethylene glycol dimethacrylate; ethylene glycol dimethacrylate, diethylene glycol dimethacrylate, aliphatic or aromatic urethane diacrylates, difunctional urethane acrylates, ethoxylated aliphatic difunctional urethane methacrylates, aliphatic or aromatic urethane dimethacrylates, epoxy acrylates, epoxymethacrylates; tetraethylene glycol dimethacrylate; polyethylene glycol dimethacrylate; 1,3 butylene glycol diacrylate; 1,4-butanediol dimethacrylate; 1,4-butaneidiol diacrylate; diethylene glycol diacrylate; 1,6 hexanediol diacrylate; 1,6 hexanediol dimethacrylate; neopentyl glycol diacrylate; polyethylene glycol diacrylate; tetraethylene glycol diacrylate; triethylene glycol diacrylate; 1,3 butylene glycol dimethacrylate; tripropylene glycol diacrylate; ethoxylated bisphenol diacrylate; ethoxylated bisphenol dimethylacrylate; dipropylene glycol diacrylate; alkoxylated hexanediol diacrylate; alkoxylated cyclohexane dimethanol diacrylate; propoxylated neopentyl glycol diacrylate, trimethylolpropane trimethacrylate; trimethylolpropane triacrylate, pentaerythritol triacrylate, ethoxylated trimethylolpropane triacrylate, propoxylated trimethylolpropane triacrylate, propoxylated glyceryl triacrylate, ditrimethylolpropane tetraacrylate, dipentaerythritol pentaacrylate, ethoxylated pentaerythritol tetraacrylate, divinyl benzene, and mixtures thereof.

### Monomers Capable of Forming a Soil Adsorbing Polymer

The soil adsorbing polymers of the present invention comprise one or more, in one example two or more, different types of monomeric units capable of forming a soil adsorbing polymer derived from corresponding soil adsorbing polymer monomers. As a result, the soil adsorbing polymers of the present invention can be referred to as homopolymers or copolymers including terpolymers and higher. In one example, the soil adsorbing polymer of the present invention is a terpolymer (3 different types of soil adsorbing polymer monomeric units). In another example, the soil adsorbing polymer of the present invention is a random copolymer. In still another example, the soil adsorbing polymer of the present invention is water-soluble and/or water-dispersible, which means that the soil adsorbing polymer does not, over at least a certain pH and concentration range, form a two-phase composition in water at 23° C.±2° C. In one example, a soil adsorbing polymer of the present invention comprises polymer comprising a monomeric unit selected from the group consisting of: acrylamide monomeric units or derivatives thereof, carboxylic acid-containing monomeric units, quaternary ammonium-containing monomeric units, other free-radically polymerizable monomeric units, and mixtures thereof.

In one example, a soil adsorbing polymer of the present invention comprises two or more soil adsorbing polymer monomeric units selected from the group consisting of: a. nonionic monomeric units; b. anionic monomeric units; c. cationic monomeric units; d. zwitterionic monomeric units; and e. mixtures thereof.

In one example, the soil adsorbing polymer comprises at least one soil adsorbing polymer monomeric unit selected from groups a and b and at least one soil adsorbing polymer monomeric unit selected from groups c and d above.

In one example, the soil adsorbing polymer comprises at least 70% wt of a soil adsorbing polymer non-ionic monomeric unit from group a.

In one example, the soil adsorbing polymer comprises at least 0.1% wt of a soil adsorbing polymer monomeric unit from group b.

In one example, soil adsorbing polymer comprises at least 0.3% wt of a soil adsorbing polymer monomeric unit from group c.

In one example, soil adsorbing polymer comprises at least 0.5% wt of a soil adsorbing polymer monomeric unit from group d.

In one example, the soil adsorbing polymer comprises at least 70% wt of a soil adsorbing polymer non-ionic monomeric unit from group a and no more than 30% wt of a soil adsorbing polymer monomeric unit selected from the group consisting of: group b, group c, group d, and mixtures thereof.

In another example, the soil adsorbing polymer comprises no more than 30% wt of a soil adsorbing polymer monomeric unit selected from the group consisting of: group b, group c, group d, and mixtures thereof.

In one example, the soil adsorbing polymer may comprise a soil adsorbing polymer non-ionic monomeric unit from group a and a soil adsorbing polymer monomeric unit from group b.

In one example, the soil adsorbing polymer may comprise a soil adsorbing polymer non-ionic monomeric unit from group a and a soil adsorbing polymer monomeric unit from group c.

In another example, the soil adsorbing polymer of the present invention may comprise a soil adsorbing polymer non-ionic monomeric unit from group a and a soil adsorbing polymer monomeric unit from group d.

In still another example, the soil adsorbing polymer of the present invention may comprise a soil adsorbing polymer monomeric unit from group b and a soil adsorbing polymer monomeric unit from group c.

In still another example, the soil adsorbing polymer of the present invention may comprise a soil adsorbing polymer monomeric unit from group b and a soil adsorbing polymer monomeric unit from group d.

In yet another example, the soil adsorbing polymer of the present invention may comprise a soil adsorbing polymer non-ionic monomeric unit from group a, a soil adsorbing polymer monomeric unit from group b, and a soil adsorbing polymer monomeric unit from group c.

In even another example, the soil adsorbing polymer of the present invention may comprise a soil adsorbing polymer non-ionic monomeric unit from group a, a soil adsorbing polymer monomeric unit from group b, and a soil adsorbing polymer monomeric unit from group d.

In yet another example, the soil adsorbing polymer of the present invention may comprise a soil adsorbing polymer non-ionic monomeric unit from group a, a soil adsorbing polymer monomeric unit from group c, and a soil adsorbing polymer monomeric unit from group d.

In another example, the soil adsorbing polymer of the present invention may comprise a soil adsorbing polymer monomeric unit from group b, a soil adsorbing polymer monomeric unit from group c, and a soil adsorbing polymer monomeric unit from group d.

In even yet another example, the soil adsorbing polymer of the present invention may comprise a soil adsorbing polymer non-ionic monomeric unit from group a, a soil adsorbing polymer monomeric unit from group b, a soil adsorbing polymer monomeric unit from group c and a soil adsorbing polymer monomeric unit from group d.

In one example, when present in the soil adsorbing polymer, the soil adsorbing polymer monomeric unit from group b and the soil adsorbing polymer monomeric unit from group c are present in the soil adsorbing polymer at a molar ratio of b:c of from about 3:1 to 1:3 and/or from about 2:1 to 1:2 and/or from about 1.3:1 to 1:1.3 and/or about 1:1 or less.

In another example, when present in the soil adsorbing polymer, the soil adsorbing polymer monomeric unit from group b and the soil adsorbing polymer monomeric unit from group d are present in the soil adsorbing polymer at a molar ratio of b:d of from about 3:1 to 1:3 and/or from about 2:1 to 1:2 and/or from about 1.3:1 to 1:1.3 and/or about 1:1 or less.

In another example, when present in the soil adsorbing polymer, the soil adsorbing polymer monomeric unit from group c and the soil adsorbing polymer monomeric unit from group d are present in the soil adsorbing polymer at a molar ratio of c:d of from about 3:1 to 1:3 and/or from about 2:1 to 1:2 and/or from about 1.3:1 to 1:1.3 and/or about 1:1 or less.

In still another example, the soil adsorbing polymer comprises a soil adsorbing polymer non-ionic monomeric unit from group a and a soil adsorbing polymer monomeric unit from group c. For example, the soil adsorbing polymer may comprise an acrylamide monomeric unit and a quaternary ammonium monomeric unit. The quaternary monomeric unit may be selected from the group consisting of: monoquaternary ammonium monomeric units, diquaternary ammonium monomeric units, and triquaternary ammonium monomeric units.

In still another example, the soil adsorbing polymer comprises a soil adsorbing polymer non-ionic monomeric unit from group a and a soil adsorbing polymer monomeric unit from group b. For example, the soil adsorbing polymer may comprise an acrylamide monomeric unit and an acrylic acid monomeric unit.

In one example, the soil adsorbing polymer may comprise at least 70% wt of the soil adsorbing polymer non-ionic monomeric unit from group a and no more than 30% wt of the soil adsorbing polymer monomeric unit from group b.

In one example, the soil adsorbing polymer may comprise at least 70% wt of the soil adsorbing polymer non-ionic monomeric unit from group a and no more than 30% wt of the soil adsorbing polymer monomeric unit from group c.

In one example, the soil adsorbing polymer may comprise at least 70% wt of the soil adsorbing polymer non-ionic monomeric unit from group a and no more than 30% wt of the soil adsorbing polymer monomeric unit from group d.

In yet another example, the soil adsorbing polymer comprises a soil adsorbing polymer monomeric unit from group b and a soil adsorbing polymer monomeric unit from group c. For example, the soil adsorbing polymer may comprise an acrylic acid monomeric unit and a quaternary ammonium monomeric unit. The quaternary ammonium monomeric unit may be selected from the group consisting of: monoquaternary ammonium monomeric units, diquaternary ammonium monomeric units, and triquaternary ammonium monomeric units. In one example, the soil adsorbing polymer may comprise no more than 25% wt of the soil adsorbing polymer monomeric unit from group b and no more than 75% wt of the soil adsorbing polymer monomeric unit from group c.

In even yet another example, the soil adsorbing polymer comprises a soil adsorbing polymer non-ionic monomeric unit from group a, a soil adsorbing polymer monomeric unit from group b and a soil adsorbing polymer monomer unit from group c. For example, the soil adsorbing polymer may comprise an acrylamide monomeric unit, an acrylic acid monomeric unit, and a quaternary ammonium monomeric unit. The quaternary ammonium monomeric unit may be selected from the group consisting of: monoquaternary ammonium monomeric units, diquaternary ammonium monomeric units, and triquaternary ammonium monomeric units. In one example, the soil adsorbing polymer may comprise at least 70% wt of the soil adsorbing polymer non-ionic monomeric unit from group a, less than 30% wt of the soil adsorbing polymer monomeric unit from group b and/or group c. In another example, the soil adsorbing polymer may comprise at least 70% wt of the soil adsorbing polymer non-ionic monomeric unit from group a, less than 30% wt of the soil adsorbing polymer monomeric unit from group b and/or group c and/or group d. In another example, the soil adsorbing polymer may comprise from 70% to about 99% wt of the soil adsorbing polymer non-ionic monomeric unit from group a, from 0.1% to about 10% wt of the soil adsorbing polymer monomeric unit from group b, and from 0.3% to about 29% wt of the soil adsorbing polymer monomeric unit from group c. In still another example, the soil adsorbing polymer may comprise from 70% to about 99% wt of the soil adsorbing polymer non-ionic monomeric unit from group a and from about 1% to 30% wt combined of the soil adsorbing polymer monomeric unit from group b and the soil adsorbing polymer monomeric unit from group c.

In one example, the soil adsorbing polymer comprises soil adsorbing polymer monomeric units derived from acrylic acid and/or quaternary ammonium compounds and/or acrylamide. In another example, the soil adsorbing polymer comprises a polyethyleneimine, such as Lupasol®, which is commercially available from BASF Corporation.

In one example, the soil adsorbing polymer comprises a flocculating agent. In another example, the soil adsorbing polymer comprises a coagulating agent, such as a polyamine.

A flocculating agent is a chemical that results in colloids and other suspended particles, especially in liquids, to aggregate. An example of a flocculating agent according to the present invention is Rhodia's Mirapol®.

A coagulating agent on the other hand, for purposes of the present invention is a chemical that results in a liquid changing into a thickened solid. An example of a coagulating agent according to the present invention is BASF Corporation's Lupasol®.

In one example, the soil adsorbing polymer comprises a polyacrylamide, such as a homopolymer of polyacrylamide, for example as Hyperfloc® NE823 and ND823, which are commercially available from Hychem, Inc.

In one example, the soil adsorbing polymer may be used as a highly concentrated inverse emulsion (for example a water-in-oil emulsion), containing greater than 10% and/or greater than 15% and/or greater than 20% and/or greater than 25% and/or greater than 30% and/or greater than 35% and/or to about 60% and/or to about 55% and/or to about 50% and/or to about 45% active. The oil phase may consist of high quality mineral oil with boiling point range of 468-529° F. or a heavy mineral oil with boiling point range of 608-968° F.

In another example the soil adsorbing polymers may be used as a highly concentrated dewatered emulsion for example dry particles suspended in a continuous oil phase, containing greater than 10% and/or greater than 15% and/or greater than 20% and/or greater than 25% and/or greater than 30% and/or greater than 35% and/or to about 60% and/or to about 55% and/or to about 50% and/or to about 45% active. The oil phase may consist of high quality mineral oil with boiling point range of 468-529° F. or a heavy mineral oil with boiling point range of 608-968° F. In one example, the soil adsorbing polymer may be used as a highly concentrated inverse emulsion wherein the continuous phase of the inverse emulsion comprises mineral oil, such as white mineral oil.

In still another example, soil adsorbing polymer may be used as a dewatered inverse emulsion, such as AD589, and CD864, which are commercially available from SNF Floerger, which consist of micron size particles of highly coiled polymer in a continuous oil phase.

The inverse emulsions of the present invention may be directly applied to a surface of an article, such as a surface of a dry fibrous structure, a surface of a wet fibrous structure and/or added to the wet-end of a papermaking process followed by crosslinking the soil adsorbing polymer.

The soil adsorbing polymers may be anionic, neutral and/or cationic under pH 7 conditions. In one example, the soil adsorbing polymer comprises a quaternary ammonium compound under pH 7 conditions. In another example, the soil adsorbing polymer comprises an amine under pH 7 conditions. In still another example, the soil adsorbing polymer comprises an acrylamide under pH 7 conditions.

The soil adsorbing polymer may comprise a polymer comprising one or more monomeric units derived from quaternary ammonium compounds, amine compounds, acrylamide compounds, acrylic acid compounds and mixtures thereof at various weight ratios within the soil adsorbing polymer.

In another example, the soil adsorbing polymer as shown in Formula I below comprises a copolymer of acrylic acid and a quaternary ammonium compound, such as a diquaternary ammonium:

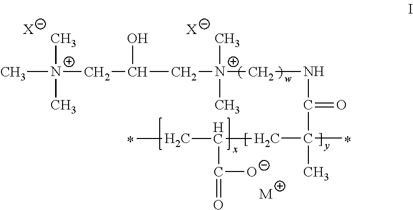

where w is an integer from 1 to 20 and/or from 2 to 15 and/or from 3 to 10; x is an integer from 1 to 100 and/or from 5 to 75 and/or from 10 to 50; y is an integer from 1 to 100 and/or from 5 to 75 and/or from 10 to 50; X⁻ is a suitable anion such as Cl⁻; and M⁺ is a suitable cation such as Na⁺. An example of such a soil adsorbing polymer is commercially from Rhodia under the trade name Mirapol®.

In another example, the soil adsorbing polymer may be a polycationic copolymer comprising:

a) at least a monomer of the general formula i:

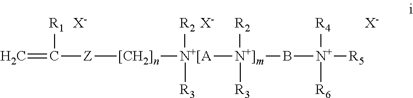

wherein R₁ is a hydrogen atom, a methyl or ethyl group; R₂, R₃, R₄, R₅ and R₆, which are identical or different, are linear or branched C₁-C₆, alkyl, hydroxyalkyl or aminoalkyl groups; m is an integer from 0 to 10; n is an integer from 1 to 6; Z represents a —C(O)O— or —C(O)NH— group or an oxygen atom; A represents a (CH₂)ₚ group, p being an integer from 1 to 6; B represents a linear or branched C₂-C₁₂, polymethylene chain optionally interrupted by one or more heteroatoms or heterogroups, and optionally substituted by one or more hydroxyl or amino groups; X⁻, which are identical or different, represent counterions; and

(b) at least one hydrophilic monomer carrying a functional acidic group which is copolymerizable with (a) and which is capable of being ionized in the application medium;

(c) optionally at least one monomer compound with ethylenic unsaturation with a neutral charge which is copolymerizable with monomer (a) and monomer (b).

The monomer (a) may be such that Z represents —C(O)O—, —C(O)NH— or O atom; n is equal to 2 or 3; m ranges from 0 to 2; represents —CH2-CH(OH)—(CH₂)q, with q from 1 to 4; and R₁ to R₆, which are identical or different, represent a methyl or ethyl group.

The copolymer may further comprise at least one monomer compound with ethylenic unsaturation with a neutral charge which is copolymerizable with monomer (a) and monomer (b).

Monomer (c) may be a hydrophilic monomer compound with ethylenic unsaturation with a neutral charge, carrying one or more hydrophilic groups, which is copolymerizable with monomer (a) and monomer (b).

Monomer (b) may be a C₃-C₈ carboxylic, sulfonic, sulfuric, phosphonic or phosphoric acids with monoethylenic unsaturation.

The copolymer may obtained by copolymerization of 3 to 80 mol %, of the monomer (a); of 10 to 95 mol %, of the monomer (b); and 0 to 50 mol %, of the monomer (c).

Monomer (a) and monomer (b) may exhibit a molar ratio by weight of the total of the monomer (a) to the total of the monomers (b) of between 80/20 and 5/95.

The copolymer may further comprise at least one monomer (d) having the general formula ii:

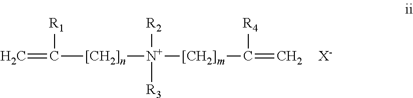

wherein R₁ and R₄ independently represent H or a C₁-C₆ linear or branched alkyl group; R₂ and R₃ independently represent a linear or branched C₁-C₆ alkyl, hydroxyalkyl or aminoalkyl group, such as a methyl group; n and m are integers of between 1 and 3; and X⁻ represents a counterion compatible with the water-soluble or water-dispersible nature of the soil adsorbing polymer.

In one example, the copolymer may further comprise at least one hydrophilic monomer (e) with an acid functionality. Non-limiting examples of such a hydrophilic monomer (e) include C₃-C₈ carboxylic, sulfonic, sulfuric, phosphonic and phosphoric acids containing monoethylenic unsaturation monomers.

The copolymer may further comprise an ethylenically unsaturated hydrophilic monomer (f) compound of neutral charge bearing one or more hydrophilic groups. Non-limiting examples of such an ethylenically unsaturated hydrophilic monomer include acrylamide, vinyl alcohol, C₁-C₄ alkyl esters of acrylic acid and of methacrylic acid, C₁-C₄ hydroxyalkyl esters of acrylic acid and of methacrylic acid, in particular ethylene glycol and propylene glycol acrylate and methacrylate, polyalkoxylated esters of acrylic acid and of methacrylic acid, in particular the polyethylene glycol and polypropylene glycol esters.

In one example, the soil adsorbing polymers of the present invention exhibit an excess charge of from about 0 to less than 0.1 meq/g and/or of less than 0.05 meq/g as measured according to the Charge Density Test Method described herein.

a. Nonionic Monomeric Units

The nonionic monomeric units may be selected from the group consisting of: nonionic hydrophilic monomeric units, nonionic hydrophobic monomeric units, and mixtures thereof.

Non-limiting examples of nonionic hydrophilic monomeric units suitable for the present invention include nonionic hydrophilic monomeric units derived from nonionic hydrophilic monomers selected from the group consisting of: hydroxyalkyl esters of α,β-ethylenically unsaturated acids, such as hydroxyethyl or hydroxypropyl acrylates and methacrylates, glyceryl monomethacrylate, α,β-ethylenically unsaturated amides such as acrylamide, N,N-dimethylmethacrylamide, N-methylolacrylamide, α,β-ethylenically unsaturated monomers bearing a water-soluble polyoxyalkylene segment of the poly(ethylene oxide) type, such as poly(ethylene oxide) α-methacrylates (Bisomer S20W, S10W, etc., from Laporte) or α,107 -dimethacrylates, Sipomer BEM from Rhodia (ω-behenyl polyoxyethylene methacrylate), Sipomer SEM-25 from Rhodia (ω-tristyrylphenyl polyoxyethylene methacrylate), α,β-ethylenically unsaturated monomers which are precursors of hydrophilic units or segments, such as vinyl acetate, which, once polymerized, can be hydrolyzed in order to give rise to vinyl alcohol units or polyvinyl alcohol segments, vinylpyrrolidones, α,β-ethylenically unsaturated monomers of the ureido type, and in particular 2-imidazolidinone-ethyl methacrylamide (Sipomer WAM II from Rhodia). In one example, the nonionic hydrophilic monomeric unit is derived from acrylamide.

Non-limiting examples of nonionic hydrophobic monomeric units suitable for the present invention include nonionic hydrophobic monomeric units derived from nonionic hydrophobic monomers selected from the group consisting of: vinylaromatic monomers such as styrene, alpha-methylstyrene, vinyltoluene, vinyl halides or vinylidene halides, such as vinyl chloride, vinylidene chloride, C₁-C₁₂ alkylesters of α,β-monoethylenically unsaturated acids such as methyl, ethyl or butyl acrylates and methacrylates, 2-ethylhexyl acrylate, vinyl esters or allyl esters of saturated carboxylic acids, such as vinyl or allyl acetates, propionates, versatates, stearates, α,β-monoethylenically unsaturated nitriles containing from 3 to 12 carbon atoms, such as acrylonitrile, methacrylonitrile, α-olefins such as ethylene, conjugated dienes, such as butadiene, isoprene, chloroprene.

b. Anionic Monomeric Units

Non-limiting examples of anionic monomeric units suitable for the present invention include anionic monomeric units derived from anionic monomers selected from the group consisting of: monomers having at least one carboxylic function, for instance α,β-ethylenically unsaturated carboxylic acids or the corresponding anhydrides, such as acrylic, methacrylic or maleic acids or anhydrides, fumaric acid, itaconic acid, N-methacroylalanine, N-acryloylglycine, and their water-soluble salts, monomers that are precursors of carboxylate functions, such as tert-butyl acrylate, which, after polymerization, give rise to carboxylic functions by hydrolysis, monomers having at least one sulfate or sulfonate function, such as 2-sulfooxyethyl methacrylate, vinylbenzene sulfonic acid, allyl sulfonic acid, 2-acrylamido-2-methylpropane sulfonic acid (AMPS), sulfoethyl acrylate or methacrylate, sulfopropyl acrylate or methacrylate, and their water-soluble salts, monomers having at least one phosphonate or phosphate function, such as vinylphosphonic acid, etc., the esters of ethylenically unsaturated phosphates, such as the phosphates derived from hydroxyethyl methacrylate (Empicryl 6835 from Rhodia) and those derived from polyoxyalkylene methacrylates, and their water-soluble salts, and 2-carboxyethyl acrylate (CEA). In one example, the anionic monomeric unit is derived from acrylic acid.

c. Cationic Monomeric Units

Non-limiting examples of cationic monomeric units suitable for the present invention include cationic monomeric units derived from cationic monomers selected from the group consisting of: N,N-(dialkylamino-w-alkyl)amides of α,β-monoethylenically unsaturated amides, such as N,N-dimethylaminomethylacrylamide or -methacrylamide, 2-(N,N-dimethylamino)ethylacrylamide or -methacrylamide, 3-(N,N-dimethylamino)propylacrylamide or -methacrylamide, and 4-(N,N-dimethylamino)butylacrylamide or -methacrylamide, α,β-monoethylenically unsaturated amino esters such as 2-(dimethylamino)ethyl acrylate (DMAA), 2-(dimethylamino)ethyl methacrylate (DMAM), 3-(dimethylamino)propyl methacrylate, 2-(tert-butylamino)ethyl methacrylate, 2-(dipentylamino)ethyl methacrylate, and 2(diethylamino)ethyl methacrylate, vinylpyridines, vinylamine, vinylimidazole, vinylimidazolines, monomers that are precursors of amine functions such as N-vinylformamide, N-vinylacetamide, which give rise to primary amine functions by simple acid or base hydrolysis, acryloyl- or acryloyloxyammonium monomers such as trimethylammonium propyl methacrylate chloride, trimethylammonium ethylacrylamide or -methacrylamide chloride or bromide, trimethylammonium butylacrylamide or -methacrylamide methyl sulfate, trimethylammonium propylmethacrylamide methyl sulfate, (3-methacrylamidopropyl)trimethylammonium chloride (MAPTAC), (3-methacrylamidopropyl)trimethylammonium methyl sulphate (MAPTA-MES), (3-acrylamidopropyl)trimethylammonium chloride (APTAC), methacryloyloxyethyl-trimethylammonium chloride or methyl sulfate, and acryloyloxyethyltrimethylammonium chloride; 1-ethyl-2-vinylpyridinium or 1-ethyl-4-vinylpyridinium bromide, chloride or methyl sulfate; N,N-dialkyldiallylamine monomers such as N,N-dimethyldiallylammonium chloride (DADMAC); polyquaternary monomers such as dimethylaminopropylmethacrylamide chloride and N-(3-chloro-2-hydroxypropyl)trimethylammonium (DIQUAT) and 2-hydroxy-N¹-(3-(2((3-methacrylamidopropyl)dimethylammino)-acetamido)propyl)-N¹,N¹,N³,N³,N³-pentamethylpropane-1,3-diaminium chloride (TRIQUAT). In one example, the cationic monomeric unit comprises a quaternary ammonium monomeric unit, for example a monoquaternary ammonium monomeric unit, a diquaternary ammonium monomeric unit and a triquaternary monomeric unit. In one example, the cationic monomeric unit is derived from MAPTAC. In another example, the cationic monomeric unit is derived from DADMAC. In still another example, the cationic monomeric unit is derived from 2-hydroxy-N¹-(3-(2((3-methacrylamidopropyl)dimethylammino)-acetamido)propyl)-N¹,N¹,N³,N³,N³-pentamethylpropane-1,3-diaminium chloride.

Dimethylaminoethyl(meth)acrylate, dimethylaminopropyl(meth)acrylate, di-tert-butylaminoethyl(meth)acrylate, dimethylaminomethyl(meth)acrylamide, dimethylaminopropyl(meth)acrylamide, ethylenimine, vinylamine, 2-vinylpyridine, 4-vinylpyridine and vinyl imidazole.

Trimethylammonium ethyl(meth)acrylate bromide, chloride or methyl sulfate, Trimethylammonium ethyl(meth)acrylate bromide, chloride or methyl sulfate, Trimethylammonium ethyl(meth)acrylate bromide, chloride or methyl sulfate, Dimethylaminoethyl(meth)acrylate benzyl chloride, 4-benzoylbenzyl dimethylammoniumethyl(meth)acrylate bromide, chloride or methyl sulfate, trimethylammonium ethyl(meth)acrylamido bromide, chloride, or methyl sulfate, trimethylammonium propyl(meth)acrylamido bromide, chloride, or methyl sulfate, vinyl benzyl trimethyl ammonium bromide, chloride or methyl sulfate, diallyldimethyl ammonium chloride, 1-ethyl-2-vinylpyridinium bromide, chloride or methyl sulfate, 4-vinylpyridinium bromide, chloride or methyl sulfate.

d. Zwitterionic Monomeric Units

Non-limiting examples of zwitterionic monomeric units suitable for the present invention include zwitterionic monomeric units derived from zwitterionic monomers selected from the group consisting of: sulfobetaine monomers, such as sulfopropyl dimethylammonium ethyl methacrylate (SPE from Raschig), sulfopropyldimethylammonium propylmethacrylamide (SPP from Raschig), and sulfopropyl-2-vinylpyridinium (SPV from Raschig), phosphobetaine monomers, such as phosphatoethyl trimethylammonium ethyl methacrylate, carboxybetaine monomers, N-(carboxymethyl)-3-methacrylamido-N,N-dimethlpropan-1-aminium chloride (CZ), 3-((3-methacrylamidopropyl)dimethylammonio)propane-1-sulfonate (SZ).

In one example, the soil adsorbing polymer of the present invention comprises a nonionic hydrophilic monomeric unit. Non-limiting examples of suitable hydrophilic monomeric units are derived from nonionic hydrophilic monomers selected from the group consisting of: hydroxyalkyl esters of α,β-ethylenically unsaturated acids, α,β-ethylenically unsaturated amides, α,β-ethylenically unsaturated monoalkyl amides, α,β-ethylenically unsaturated dialkyl amides, α,β-ethylenically unsaturated monomers bearing a water-soluble polyoxyalkylene segment of the poly(ethylene oxide) type, α,β-ethylenically unsaturated monomers which are precursors of hydrophilic units or segments, vinylpyrrolidones, α,β-ethylenically unsaturated monomers of the ureido type, and mixtures thereof. In one example, the nonionic hydrophilic monomeric unit is derived from acrylamide.

In another example, the soil adsorbing polymer of the present invention comprises a nonionic hydrophobic monomeric unit. Non-limiting examples of suitable nonionic hydrophobic monomeric units are derived from nonionic hydrophobic monomers selected from the group consisting of: vinylaromatic monomers, vinyl halides, vinylidene halides, C₁-C₁₂ alkylesters of α,β-monoethylenically unsaturated acids, vinyl esters of saturated carboxylic acids, allyl esters of saturated carboxylic acids, α,β-monoethylenically unsaturated nitriles containing from 3 to 12 carbon atoms, α-olefins, conjugated dienes, and mixtures thereof.

In one example, the soil adsorbing polymer comprises an anionic monomeric unit. Non-limiting examples of suitable anionic monomeric units are derived from anionic monomers selected from the group consisting of: monomers having at least one carboxylic function, for instance α,β-ethylenically unsaturated carboxylic acids or the corresponding anhydrides, monomers that are precursors of carboxylate functions, monomers having at least one sulfate or sulfonate function, monomers having at least one phosphonate or phosphate function, esters of ethylenically unsaturated phosphates, and mixtures thereof. In one example, the anionic monomeric unit is derived from an anionic monomer selected from the group consisting of: acrylic acid, methacrylic acid, 2-acrylamido-2-methylpropane sulfonic acid, carboxyethyl acrylate, and mixtures thereof.

In one example, the soil adsorbing polymer comprises a cationic monomeric unit. Non-limiting examples of suitable cationic monomeric units are derived from cationic monomers selected from the group consisting of: acryloyl- or acryloyloxyammonium monomers, 1-ethyl-2-vinylpyridinium or 1-ethyl-4-vinylpyridinium bromide, chloride or methyl sulfate, N,N-dialkyldiallylamine monomers, polyquaternary monomers, N,N-(dialkylamino-ω-alkyl)amides of α,β-monoethylenically unsaturated carboxylic acids, α,β-monoethylenically unsaturated amino esters, vinylpyridines, vinylamine, vinylimidazolines, monomers that are precursors of amine functions which give rise to primary amine functions by simple acid or base hydrolysis, and mixtures thereof. In one example, the cationic monomeric unit is derived from MAPTAC. In another example, the cationic monomeric unit is derived from DADMAC. In still another example, the cationic monomeric unit is derived from 2-hydroxy-N¹-(3-(2((3-methacrylamidopropyl)dimethylammino)-acetamido)propyl)-N¹,N¹,N³,N³,N³-pentamethylpropane-1,3-diaminium chloride.

The soil adsorbing polymer of the present invention may comprise a non-ionic acrylamide-derived monomeric unit (group a) and a quaternary ammonium-derived monomeric unit (group c). The quaternary ammonium-derived monomeric unit may be selected from the group consisting of: monoquaternary ammonium-derived monomeric units, diquaternary ammonium-derived monomeric units, and triquaternary-derived ammonium monomeric units. In one example, the soil adsorbing polymer comprises at least 70% wt of a non-ionic monomeric unit from group a and no more than 30% wt of a monomeric unit from group c.

The soil adsorbing polymer of the present invention may comprise a non-ionic acrylamide-derived monomeric unit (group a) and an acrylic acid monomeric unit (group b). In one example, the soil adsorbing polymer comprises at least 70% wt of a non-ionic monomeric unit from group a and no more than 30% wt of a monomeric unit from group b. The soil adsorbing polymer of the present invention may comprise a non-ionic acrylamide-derived monomeric unit (group a) and a zwitterionic (with both carboxylic acid and ammonium groups) monomeric unit (group d). In another example, the soil adsorbing polymer may comprise an acrylamide-derived monomeric unit and a N-(carboxymethyl)-3-methacrylamido-N,N-dimethylpropan-1-aminium chloride-derived monomeric unit.

In another example, the soil adsorbing polymer may comprise a non-ionic acrylamide-derived monomeric unit (group a) and a zwitterionic (with both sulfonate and ammonium groups) monomeric unit (group d). In another example, the soil adsorbing polymer may comprise an acrylamide-derived monomeric unit and a 3-((3-methacrylamidopropyl)dimethylammonio)propane-1-sulfonate-derived monomeric unit.

In one example, the soil adsorbing polymer comprises at least 70% wt of the non-ionic monomeric unit from group a and no more than 30% wt of the monomeric unit from group b.

In one example, the soil adsorbing polymer comprises at least 70% wt of the non-ionic monomeric unit from group a and no more than 30% wt of the monomeric unit from group c.

In one example, the soil adsorbing polymer comprises at least 70% wt of the non-ionic monomeric unit from group a and no more than 30% wt of the monomeric unit from group d.

In one example, the soil adsorbing polymer may comprise at least 70% wt of the non-ionic monomeric unit from group a, less than 30% wt of the monomeric unit from group b and less than 30% wt of the monomeric unit from group c. In another example, the soil adsorbing polymer may comprise from 70% to about 99% wt of the non-ionic monomeric unit from group a, from 0.1% to about 10% wt of the monomeric unit from group b, and from 0.3% to about 25% wt of the monomeric unit from group c. In still another example, the soil adsorbing polymer may comprise from 70% to about 99% wt of the non-ionic monomeric unit from group a and from about 1% to 30% wt combined of the monomeric unit from group b and the monomeric unit from group c.

In still another example, the soil adsorbing polymer of the present invention may comprise at least 70% wt of the non-ionic monomeric unit from group a, less than 30% wt of the monomeric unit from group b and less than 30% wt of the monomeric unit from group d. In another example, the soil adsorbing polymer may comprise from 70% to about 99% wt of the non-ionic monomeric unit from group a, from 0.1% to about 10% wt of the monomeric unit from group b, and from 0.5% to about 29% wt of the monomeric unit from group d. In even still another example, the soil adsorbing polymer may comprise from 70% to about 99% wt of the non-ionic monomeric unit from group a and from about 1% to 30% wt combined of the monomeric unit from group b and the monomeric unit from group d.

In yet another example, the soil adsorbing polymer may comprise at least 70% wt of the non-ionic monomeric unit from group a, less than 30% wt of the monomeric unit from group c and less than 30% wt of the monomeric unit from group d. In still another example, the soil adsorbing polymer may comprise from 70% to about 99% wt of the non-ionic monomeric unit from group a, from 0.3% to about 10% wt of the monomeric unit from group b, and from 0.5% to about 29% wt of the monomeric unit from group d. In even still another example, the soil adsorbing polymer may comprise from 70% to about 99% wt of the non-ionic monomeric unit from group a and from about 1% to 30% wt combined of the monomeric unit from group c and the monomeric unit from group d.

In one example, the soil adsorbing polymer of the present invention is water soluble.

### Reactive Monomers

Reactive monomeric units of the present invention are derived from corresponding reactive monomers. Reactive monomers are monomers that include a reactive group, such as a epoxy, azetidinium, acid halides, active esters, alkyl halides, azo, glycidyl methacrylate, periodate, second functionality groups.

### Free Radical Generating Sources

Any free radical generating source capable of creating a reactive site on an article and/or article-forming component of the present invention may be used. Non-limiting examples of free radical generating sources include radiation sources. Non-limiting examples of radiation sources include gamma radiation (Cobalt 60, Cesium 137), x-rays, UV light, microwaves, and mixtures thereof. Non-limiting examples of other suitable free radical generating sources include corona and gas, such as oxygen and/or air, and reactive azo and/or peroxy molecules.

### Processes for Making a Durably Bonded Soil Adsorbing Article

The articles of the present invention may be made by any suitable process known in the art. The soil adsorbing polymer may be grafted to the article (or article-forming component) and/or the soil adsorbing polymer may be grafted from the article (or article-forming component) and/or the soil adsorbing polymer may be grafted through the article (or article-forming component) and/or the soil adsorbing polymer may be entangled with the article. In one case, an existing soil adsorbing polymer may contact an article (or article-forming component) under conditions that durably bond the soil adsorbing polymer and/or monomers capable of forming a soil adsorbing polymer to the article (or article-forming component). In another case, one or more monomers used to make a soil adsorbing polymer (“monomers capable of forming a soil adsorbing polymer”) may be grafted to an article (or article-forming component) and then the grafted monomer(s) may be polymerized with additional monomers capable of forming a soil adsorbing polymer to build a soil adsorbing polymer from the article (or article-forming component).

Even though the following examples reference articles of the present invention, they are also applicable to article-forming components of the present invention.

In one example, a soil adsorbing polymer is durably bonded to an article by contacting the article with a soil adsorbing polymer under the following conditions: a temperature of at least 30° C. and/or at least 40° C. and/or at least 60° C. and/or at least 70° C. and/or from about 30° C. to about 120° C. and/or from about 70° C. to about 120° C.; time ranging from at least 1 minute and/or at least 5 minutes and/or at least 1 hour and/or at least 2 hours and/or at least 6 hours and/or at least 12 hours and/or at least 24 hours.

Further, solvents and/or catalysts may be used to speed up the reaction and lower the temperature required. Catalysts depend on the exact reaction. For example, amines may be used for acid chloride reactions and bases such as sodium hydroxide may be used for epoxy reactions.

The article may comprise a reactive group to which a soil adsorbing polymer and/or monomers capable of forming a soil adsorbing polymer may and/or does react. Non-limiting examples of reactive groups on the article include —C═C— and —OH. Alternatively or in addition, the soil adsorbing polymer comprises a reactive group through which the soil adsorbing polymer may react and/or does react with the article. Non-limiting examples of reactive groups on the soil adsorbing polymer include epoxy, azetidinium, acid halides, active esters, alkyl halides, second functionality groups (some kind of vinyl group capable of free radical polymerization—acrylic acid, methacrylic acid, styrene, acrylamides).

In one example, the step of contacting the article with a soil adsorbing polymer comprises the step of subjecting the article in the presence of the soil adsorbing polymer to a temperature of at least 20° C. and/or at least 25° C. and/or at least 30° C. and/or at least 34° C. and/or at least 60° C. and/or less than 300° C. and/or less than 250° C. and/or less than 200° C. and/or less than 150° C.

In another example, the step of contacting the article with a soil adsorbing polymer comprises the step of subjecting the article, optionally in the presence of the soil adsorbing polymer, to radiation. Non-limiting examples of radiation sources include gamma radiation (Cobalt 60, Cesium 137), x-rays, UV light, and microwaves. Another example is to subject the article, optionally in the presence of the soil adsorbing polymer, to corona and gas, such as oxygen and/or air, (creates a surface only chemistry—a hydroxyl group) and then polymerize the soil adsorbing polymer from the —OH.

The step of contacting the article with a soil adsorbing polymer may further comprise the step of contacting the article with a liquid composition comprising the soil adsorbing polymer. The liquid composition may be an aqueous solution.

After and/or during contacting the article with the liquid composition comprising the soil adsorbing polymer, the article may be subjected to a temperature of at least 30° C., 40° C., 50° C., 60° C.

After contacting the article with a soil adsorbing polymer and/or monomers capable of forming a soil adsorbing polymer, the article may be washed, for example with water (or water containing 1% w/v sodium bicarbonate), such as by running a soxhlet on the article in water to remove any non-durably bonded soil adsorbing polymer from the article (or article-forming component).

If the article is a web, such as a fibrous structure, for example a wipe or paper towel, any suitable web making process to form the web may be used.

In one example, the article comprises a fibrous structure. The fibrous structure may be made by a process comprising the step of contacting a surface of the fibrous structure with a soil adsorbing polymer according to the present invention. In another example, the fibrous structure may be made by a process comprising the step of adding a soil adsorbing polymer according to the present invention to a fiber slurry that is used to produce the fibrous structure.

In another example of a process for making an article, such as a fibrous structure, the process comprises the steps of:
a. providing a fiber slurry;
b. depositing the fiber slurry onto a foraminous wire to form an embryonic web;
c. drying the embryonic web to produce a fibrous structure; and
d. contacting the fibrous structure with a soil adsorbing polymer such that the soil adsorbing polymer is durably bonded to the article forming a treated article according to the present invention (for example, a fibrous structure, such as a dry fibrous structure).

The soil adsorbing polymers of the present invention may be made prior to durably bonding the soil adsorbing polymers to the articles and/or article-forming components of the present invention. For example, a soil adsorbing polymer may be made by copolymerizing one or more soil adsorbing polymer monomers with one or more reactive monomers to form a reactive soil adsorbing polymer that may then durably bond to an article and/or article-forming component.

### Non-limiting Examples of Articles and Article-Forming Components of the Present Invention

Table 1 below sets forth various inventive and comparative example substrates and data regarding whether the substrates contain a durably bonded soil adsorption polymer.

TABLE 1

| | | | | |
|---|---|---|---|---|
| | | After | After | Reference |
| | | Water | Bicarbonate | (Untreated |
| Example # | Substrate | Wash | Wash | Substrate) |

Grafting To

| | | | | |
|---|---|---|---|---|
| 1A | Albaad Baby Wipe | 77.1 ± 4.7 | 62.0 ± 2.6 | 28.7 ± 2.3 |
| | Substrate | | | |
| 1B | Albaad Baby Wipe | 78.3 ± 2.2 | 60.2 ± 4.1 | 28.7 ± 2.3 |
| | Substrate | | | |
| 1C | Albaad Baby Wipe | 75.7 ± 2.8 | 63.9 ± 2.7 | 28.7 ± 2.3 |
| | Substrate | | | |
| 2A | Albaad Baby Wipe | 85.9 ± 2.4 | 68.6 ± 1.8 | 34.7 ± 0.9 |
| | Substrate | | | |
| 2B | Albaad Baby Wipe | 97.0 ± 2.1 | 77.4 ± 2.5 | 34.7 ± 0.9 |
| | Substrate | | | |
| 2C | Albaad Baby Wipe | 88.2 ± 2.7 | 75.1 ± 1.2 | 34.7 ± 0.9 |
| | Substrate | | | |
| 2D | Albaad Baby Wipe | 84.7 ± 2.1 | 63.6 ± 2.8 | 34.7 ± 0.9 |
| | Substrate | | | |
| 2E | Albaad Baby Wipe | 101.0 ± 1.4 | 76.2 ± 2.5 | 34.7 ± 0.9 |
| | Substrate | | | |
| 2F | Albaad Baby Wipe | 89.7 ± 4.4 | 71.3 ± 2.4 | 34.7 ± 0.9 |
| | Substrate | | | |
| 2G | Albaad Baby Wipe | 77.4 ± 3.9 | 64.6 ± 2.7 | 34.7 ± 0.9 |
| | Substrate | | | |
| 2H | Albaad Baby Wipe | 90.8 ± 2.6 | 70.2 ± 4.8 | 34.7 ± 0.9 |
| | Substrate | | | |
| 2I | Albaad Baby Wipe | 70.1 ± 7.8 | 52.8 ± 11.3 | 34.7 ± 0.9 |
| | Substrate | | | |
| 3A | Albaad Baby Wipe | 56.1 ± 1.7 | 59.0 ± 2.4 | 28.1 ± 3.5 |
| | Substrate | | | |
| 3B | Albaad Baby Wipe | 62.9 ± 2.8 | 46.5 ± 5.3 | 28.1 ± 3.5 |
| | Substrate | | | |

Grafting From

| | | | | |
|---|---|---|---|---|
| 4 | Bounty ® Paper | NR | NR | NR |
| | Towel | | | |
| 5 | VWR Cotton Pad | 109.0 ± 13.6 | 97.0 ± 7.1 | 42.9 ± 2.8 |

Grafting Through

| | | | | |
|---|---|---|---|---|
| 6 | Albaad Baby Wipe | 156.8 ± 14.2 | 101.0 ± 1.9 | 24.3 ± 1.6 |
| | Substrate | | | |
| 7A | Albaad Baby Wipe | 135.4 ± 2.8 | 129.6 ± 1.9 | 30.5 ± 1.5 |
| | Substrate | | | |
| 7B | Albaad Baby Wipe | 116.1 ± 9.5 | 102.1 ± 6.7 | 30.5 ± 1.5 |
| | Substrate | | | |
| 7C | Albaad Baby Wipe | 164.4 ± 1.3 | 163.9 ± 2.3 | 30.5 ± 1.5 |
| | Substrate | | | |
| 7D | Albaad Baby Wipe | 130.7 ± 1.1 | 127.2 ± 1.9 | 30.5 ± 1.5 |
| | Substrate | | | |
| 8A | Bounty ® Paper | NR | 167.1 ± 2.4 | 51.9 ± 3.5 |
| | Towel | | | |
| 8B | Core 1 | NR | 148.3 ± 15.6 | 49.0 ± 7.0 |
| 9A | Core 2 | NR | 121.1 ± 5.1 | 79.1 ± 1.7 |
| 9B | MBCF 1 | NR | 94.9 ± 5.8 | 36.0 ± 2.0 |
| 9C | Albaad Baby Wipe | NR | 105.9 ± 20.2 | 27.1 ± 1.5 |
| | Substrate | | | |
| 9D | Terry Cloth | NR | 150.8 ± 7.8 | 53.9 ± 5.1 |
| 10 | MBCF 1 | NR | 94.3 ± 7.0 | 36.0 ± 2.0 |
| 11A | SP | NR | 81.5 ± 10.1 | 35.4 ± 2.8 |
| 11B | PET/Nylon | NR | 86.6 ± 4.5 | 21.4 ± 3.2 |
| | Substrate | | | |
| 11C | MBCF 2 | NR | 78.0 ± 5.2 | 31.9 ± 4.2 |
| 11D | Albaad Baby Wipe | NR | 79.4 ± 2.1 | 28.8 ± 3.5 |
| | Substrate | | | |
| 11E | MBCF 1 | NR | 86.1 ± 1.9 | 33.6 ± 4.2 |
| 11F | Terry Cloth | NR | 161.5 ± 3.8 | 72.1 ± 1.9 |
| 12 | Baby Wipe A | 132.4 ± 19.6 | 148.0 ± 10.1 | 45.9 ± 1.8 |
| 12 | Baby Wipe B | 135.5 ± 12.1 | 107.4 ± 3.3 | 29.9 ± 1.2 |
| 13 | Fibrella 2000 | NR | 64.3 ± 3.3 | 16.7 ± 0.5 |
| 14 | O-Cel-O ™ Sponge | NR | 121.35 ± 7.86 | 92.43 ± 22.12 |

Entanglement

| | | | | |
|---|---|---|---|---|
| 15 | Albaad Baby Wipe | 167.1 ± 6.4 | 167.9 ± 3.1 | 24.3 ± 1.6 |
| | Substrate | | | |
| 16 | Albaad Baby Wipe | 111.5 ± 5.6 | 103 ± 1.7 | 24.3 ± 1.6 |
| | Substrate | | | |

Not Durably Bonded

| | | | | |
|---|---|---|---|---|
| Comparative | Albaad Baby Wipe | 112.9 ± 3.4 | 27.5 ± 1.5 | 28.2 ± 5.7 |
| Example | Substrate | | | |
| 1A | | | | |
| Comparative | Albaad Baby Wipe | 70.7 ± 4.0 | 8.6 ± 0.3 | 24.3 ± 1.6 |
| Example | Substrate | | | |
| 1B | | | | |
| Comparative | Albaad Baby Wipe | 94.0 ± 3.0 | 12.5 ± 1.3 | 24.3 ± 1.6 |
| Example | Substrate | | | |
| 1C | | | | |

Coated and washes off - Not Durably Bonded

| | | | | |
|---|---|---|---|---|
| Comparative | Albaad Baby Wipe | 111.4 ± 4.5 | 29.3 ± 2.1 | 24.3 ± 1.6 |
| Example | Substrate | (as made | | |
| 2A | | prior to | | |
| | | water | | |
| | | wash) | | |
| Comparative | Albaad Baby Wipe | 165.6 ± 1.4 | 25.3 ± 0.4 | 24.3 ± 1.6 |
| Example | Substrate | (as made | | |
| 2B | | prior to | | |
| | | water | | |
| | | wash) | | |
| Comparative | Albaad Baby Wipe | 63.3 ± 2.2 | 34.5 ± 5.9 | 28.1 ± 3.5 |
| Example | Substrate | | | |
| 3A | | | | |
| Comparative | Albaad Baby Wipe | 48.7 ± 3.9 | 25.9 ± 1.3 | 28.1 ± 3.5 |
| Example | Substrate | | | |
| 3B | | | | |

### Substrates for the Non-Limiting Examples

Wet laid paper towels—100% wood pulp fiber paper towel examples—commercially available Bounty® paper towel from The Procter & Gamble Company, manufactured in 2008.

LBAL (latex bonded airlaid) baby wipe substrate—a 65 gsm airlaid substrate (about 70% wood pulp fibers) available from Albaad USA of Reidsville, N.C.

PET/Nylon substrate—40 gsm hydroentangled 70% PET/30% Nylon substrate available from Freudenberg Nonwovens under the tradename Evolon.

Meltblown, coformed substrate (“MBCF1”)—55 gsm 70% pulp/30% polypropylene filaments.

Meltblown, coformed substrate (“MBCF2”)—65 gsm 70% pulp/30% polypropylene filaments.

MBAL airlaid substrate (“Core 1”)—270 gsm 15% PE/PET bicomponent staple fibers/82% pulp fibers/3% latex available from Glatfelter of York, Pa.

TBAL airlaid substrate (“Core 2”)—270 gsm 18% PE/PET bicomponent staple fibers/82% pulp fibers available from Glatfelter of York, Pa.

Terry cloths—(6 inches×6 inches) available from Euro Touch, EuroTouch 100% Cotton AN17910; made in China; www.standardtextile.com (http://www.standardtextile.com/)

Cotton Pad—available from VWR

Tufted Spunbond Polypropylene Substrate (“SP”)—4-layered, low bond, two 2014 Bounty® paper towels sandwiched between two 25-30 gsm spunbond polypropylene web.

Baby Wipe A—45 gsm, 40/40/20 PET/PP/Cotton carded spunlace substrates—before lotioning (available from Suominen of Helsinki, Finland).

Baby Wipe B—45 gsm, 40/40/20 PET/PP/Viscose carded spunlace substrates—before lotioning (available from Suominen of Helsinki, Finland).

Fibrella 2000 Substrate—30 gsm, spunlace STS, 67% Viscose/33% PET substrate (available from Suominen of Helsinki, Finland).

O-Cel-O™ Sponge (available from 3M of St. Paul, Minn.).

### Examples 1A-1C

### Grafting to (Albaad Baby Wipe Substrates)

a. Preparing a Reactive Soil Adsorbing Polymer

An initiator solution is made by diluting 0.5 grams of 2,2′-azobis(N,N′-dimethyleneisobutyramidine)dihydrogen chloride (available from Wako Chemicals, Richmond, Va. as VA-044) to a final volume of 5 mL with deionized water.

The quantities of glycidyl methacrylate (“GMA”) (available from Aldrich Chemical, Milwaukee, Wis., USA) and acrylamide (“AAM”) (available from Aldrich Chemical, Milwaukee, Wis., USA) shown in Table 2 below as concentrates A, B and C, are each dissolved in 455 mL of deioinzed water each in a separate reaction vessel, each sealed with a septum, and heated in a water bath set at 45° C. for 2 hours. After 2 hours each vessel is sparged with Argon for 3 minutes at approximately 5 mL/second. During minute 2, 1 mL of initiator solution from above is injected into each vessel. All three vessels are placed in a 45° C. vented laboratory drying oven for 24 hours. After 24 hours, the materials are cooled to 21° C.±2° C.

TABLE 2

| | Acrylamide | Glycidyl methacrylate | |
|---|---|---|---|
| Sample | (grams) | (grams) | Water (mL) |
| Concentrate A | 23.53 | 0.47 | 455 |
| Concentrate B | 23.76 | 0.24 | 455 |
| Concentrate C | 23.97 | 0.027 | 455 |

The solids levels are determined and the polymerized concentrates are diluted to 0.02% solids with water (herein referred to as Solution A, B, and C respectively) (“reactive soil adsorbing polymer”).

b. Durably Bonding Reactive Soil Adsorbing Polymer to Article

24 Albaad baby wipe substrates are cut to dimensions 3 inch×4 inch to make 24 samples and then conditioned at 21° C.±2° C. and 50%±2% relative humidity for 16 hours. The 24 samples are divided into six batches of 4 each. The weight of each batch is recorded as the Weight of Starting Sample in the Table 3 below.

TABLE 3

| | Weight of | Weight of Durably Bonded | Weight of |
|---|---|---|---|
| Batch | Starting Sample | Soil Adsorbing Sample | Washed Sample |
| A-1 | 2.0009 grams | 2.0161 grams | 2.0155 grams |
| A-2 | 2.0099 grams | 2.0248 grams | 2.0234 grams |
| B-1 | 2.1143 grams | 2.1295 grams | 2.1288 grams |
| B-2 | 2.0082 grams | 2.0232 grams | 2.0221 grams |
| C-1 | 1.9671.grams | 1.9818 grams | 1.9804 grams |
| C-2 | 2.0526 grams | 2.0689 grams | 2.0678 grams |

Batches A-1 and A-2 are each saturated in a bucket with 3.8 mL of the 0.02% of Solution A from above to durably bond the reactive soil adsorbing polymer to the samples. Batches B-1 and B-2 are each saturated in a bucket with 3.8 mL of the 0.02% of Solution B from above to durably bond the reactive soil adsorbing polymer to the samples. Batches C-1 and C-2 are each saturated in a bucket with 3.8 mL of the 0.02% of Solution C from above to durably bond the reactive soil adsorbing polymer to the samples. The saturated samples are removed from their respective buckets and air dried for 2 hours on plastic meshes. Then each batch of samples is placed in a 60° C. vented oven for 16 hours. After 16 hours, the samples are removed from the oven and each batch of samples is conditioned at 21° C.±2° C. and 50%±2% for 2 hours. After 2 hours the weight of each of the durably bonded soil adsorbing batches is determined and recorded as the Weight of Durably Bonded Soil Adsorbing Sample in Table 3 above.

Batches ending in -1 (listed as After Water Wash in Table 1), are rinsed with 2 gallons of deionized water. Each batch of samples is then placed into separate 2 gallon containers with 800 mL of deionized water. Each batch of samples is allowed to soak in this water for 2 hours followed by a filtration and rinse with 400 mL of fresh deionized water in a Büchner funnel. The soak and rinse steps are repeated 3 more times. After the final rinse step, each batch of samples is conditioned at 21° C.±2° C. and 50%±2% humidity for 48 hours to dry and equilibrate. After 48 hours each batch of samples is weighed and is recorded as Weight of Washed Sample in Table 3 above.

Batches ending in -2 (listed as After Bicarbonate Wash in Table 1) are rinsed with 2 gallons of deionized water. Each batch of samples is then placed into separate 2 gallon containers with 800 mL of a 1% w/v sodium bicarbonate solution. Each batch of samples is allowed to soak in this sodium bicarbonate solution for 2 hours followed by a filtration and rinse with fresh 1% sodium bicarbonate solution in a Büchner funnel. The soak and rinse are repeated 2 more times with fresh 1% sodium bicarbonate solution. An additional soak and rinse using deionized water is performed. After the final rinse step, each batch of samples is conditioned at 21° C.±2° C. and 50%±2% humidity for 48 hours to dry and equilibrate. After 48 hours each batch of samples is weighed and is recorded as Weight of Washed Sample in Table 3 above.

The durably bonded soil adsorbing samples made using A, B, and C polymer solutions are then tested according to the Soil Adsorption Test Method described herein and the data is shown in Table 1 above.

### Examples 2A-2I

### Grafting to (Albaad Baby Wipe Substrates)

a. Preparing a Reactive Soil Adsorbing Polymer

Into a 100 mL round bottom flask are added 9.51 g of diallylamine (available from Aldrich Chemical, Milwaukee, Wis., USA), 9.51 g of epichlorohydrin (available from Aldrich Chemical, Milwaukee, Wis., USA) and 9.52 g of 2-propanol (available from Aldrich Chemical, Milwaukee, Wis., USA). The flask is then heated to 30° C. for 5.5 hours. After 5.5 hours, the solvents in the flask are removed by rotary evaporation. The yield is 16.70 g. To this product 16.72 grams of deionized water are added and the contents are refluxed. After refluxing for 1 hour and 10 minutes the flask is removed from the heating bath. The flask is cooled and the material placed into a 60 mL separatory funnel. The product is isolated from the yellowish lower aqueous layer. The yield is 30.35 g of 1,1-diallyl-3-hydroxyazetidnium.

Next, 0.48 grams of a 50% solution (in water) of 1,1-diallyl-3-hydroxyazetidnium, 456 mL of water and 23.76 grams of acrylamide (available from Aldrich Chemicals, Milwaukee, Wis.) are added to a reaction vessel. Then, 0.1 grams of 2,2′-azobis(N,N′-dimethyleneisobutyramidine)dihydrogen chloride (available from Wako Chemicals, Richmond, Va. as VA-044) is added and the solution is purged with argon for 5 minutes at 5 mL/sec and heated at 45° C. for 16 hours to form a reactive soil adsorbing polymer; namely, poly(acrylamide-co-1,1-diallyl-3-hydroxyazetidnium). The solution is then removed from the heat source and stored at 4° C.

b. Durably Bonding Reactive Soil Adsorbing Polymer to Article

120 Albaad baby wipe substrates are cut to dimensions 3 inch×4 inch and then conditioned at 21° C.±2° C. and 50%±2% humidity for 2 hours. After conditioning the wipes are divided into 28 groups of 4 samples each as indicated in Table 4 below. The initial mass of each group is determined and recorded as shown in Table 4 below.

TABLE 4

| | | | | Mass of | |
|---|---|---|---|---|---|
| | | | | samples after | |
| | | | Initial | treatment | Sample |
| | Sample | | Mass of | and | mass (g) |
| Sample | Group - | Sample | Group | equillibration | after |
| Set # | Subgroup | Group | (g) | (g) | washing |
| 1 | A-1 | 1 | 2.141 | 2.166 | 2.166 |
| 1 | A-2 | 2 | 2.186 | 2.210 | 2.202 |
| 1 | A-3 | 3 | 2.098 | 2.122 | 2.116 |
| 1 | B-1 | 4 | 2.101 | 2.115 | 2.124 |
| 1 | B-2 | 5 | 2.091 | 2.107 | 2.111 |
| 1 | B-3 | 6 | 2.078 | 2.099 | 2.097 |
| 1 | C-1 | 7 | 2.041 | 2.076 | 2.072 |
| 1 | C-2 | 8 | 2.144 | 2.180 | 2.159 |
| 1 | C-3 | 9 | 2.233 | 2.270 | 2.251 |
| 2 | D-1 | 10 | 2.169 | 2.200 | 2.202 |
| 2 | D-2 | 11 | 2.143 | 2.174 | 2.160 |
| 2 | D-3 | 12 | 2.124 | 2.151 | 2.140 |
| 2 | E-1 | 13 | 2.112 | 2.130 | 2.135 |
| 2 | E-2 | 14 | 2.043 | 2.065 | 2.062 |
| 2 | E-3 | 15 | 2.012 | 2.031 | 2.029 |
| 2 | F-1 | 16 | 2.044 | 2.085 | 2.082 |
| 2 | F-2 | 17 | 2.028 | 2.070 | 2.045 |
| 2 | F-3 | 18 | 2.083 | 2.124 | 2.100 |
| 3 | G-1 | 19 | 2.122 | 2.156 | 2.153 |
| 3 | G-2 | 20 | 2.085 | 2.119 | 2.101 |
| 3 | G-3 | 21 | 2.094 | 2.128 | 2.109 |
| 3 | H-1 | 22 | 2.087 | 2.108 | 2.106 |
| 3 | H-2 | 23 | 2.121 | 2.141 | 2.139 |
| 3 | H-3 | 24 | 2.065 | 2.088 | 2.079 |
| 3 | I-1 | 25 | 2.041 | 2.075 | 2.071 |
| 3 | I-2 | 26 | 2.079 | 2.112 | 2.089 |
| 3 | I-3 | 27 | 2.092 | 2.128 | 2.105 |
| 4 | J-1 | 28 | 2.087 | 2.099 | 2.101 |

A 0.04% aqueous carboxymethylcellulose (CMC) solution is made by adding 0.20020 g CMC4 (available from Noviant, Aanekoski, Finland) to 500.50 g deionized water. To Set 2, 3.8 mL of the 0.04% aqueous CMC solution is applied to each sample. All samples in set 2 are conditioned at 21° C.±2° C. and 50%±2% humidity for 48 hours.

Separately, a 0.04% aqueous solution of poly(acrylamide-co-1,1-diallyl-3-hydroxyazetidnium), which was made above, is made by diluting the poly(acrylamide-co-1,1-diallyl-3-hydroxyazetidnium) solution from above to a total of 500 g with water. Separately, 3.8 mL of a 0.04% aqueous solution of poly(acrylamide-co-1,1-diallyl-3-hydroxyazetidnium), from above, is applied to each sample in Sets 1 and 2. Of Sets 1 and 2, groups “A” and “D” are allowed to air dry in the room at 22% humidity and 20° C. for 6 hours suspended on a wire mesh. Groups “B” and “E” are heated to 65° C.±5° C. and allowed to dry over a period of 2 hours. Groups “C” and “F” are placed in a sealed polyethylene bag and heated to 65° C.±5° C. for 2 hours then removed from heat and from the bag and allowed to air dry in the room at 22% humidity and 20° C. for 6 hours suspended on a wire mesh. For Set 3, a solution containing 80.33 g of 0.04% poly(acrylamide-co-1,1-diallyl-3-hydroxyazetidnium), from above, and 80.23 g of 0.04% CMC4 solution, from above, is made. 3.8 mL of this resulting solution is then applied to each sample in Set 3. Group “G” is allowed to air dry in the room at 22% humidity and 20° C. for 16 hours suspended on a wire mesh. Group “H” is heated to 65° C.±5° C. for 2 hours and then air dried in the room at 22% humidity and 20° C. for 16 hours suspended on a wire mesh. Group “I” is placed in a sealed polyethylene bag and heated to 65° C.±5° C. for 2 hours, then removed from both heat and bag and then air dried in the room at 22% humidity and 20° C. for 16 hours suspended on a wire mesh. Set 4, Group “J” samples (comparative samples) are treated with 3.8 mL of deionized water and air dried in the room at 22% humidity and 20° C. for 16 hours suspended on a wire mesh. All samples are conditioned at 21° C.±2° C. and 50%±2% humidity for 16 hours. Sample subgroup masses are then obtained and recorded (mass of samples after treatment and equilibration) in Table 4 above. All subgroups ending in “2” (listed as After Water Wash in Table 1) are placed in buckets with 200 mL of deionized water and are allowed to soak for 2 hours followed by a wash using 200 mL deionized water per subset in a Büchner funnel, then another soak for 2 hours. This process is repeated for a total of 3 soaks and 3 washes with deionized water. All subgroups ending in “3” (listed as After Bicarbonate Wash in Table 1) went through 2 similar soaks in 200 mL of 1% aqueous sodium bicarbonate, then 2, 200 mL washes with 1% aqueous sodium bicarbonate after each soak. Subgroup “3” samples went through a final 200 mL soak in deionized water followed by a 200 mL deionized water wash. Subgroup “1” samples did not have any soak or wash steps. After all soaks/washes are complete, all samples are conditioned at 21° C.±2° C. and 50%±2% humidity for 16 hours. Sample masses are then recorded again (sample mass after washing) as shown in Table 4 above.

The durably bonded soil adsorbing samples are then tested according to the Soil Adsorption Test Method described herein and the data is shown in Table 1 above.

### Examples 3A-3B

### Grafting to (Albaad Baby Wipe Substrates)

a. Preparing Monomers Capable of Forming a Soil Adsorbing Polymer

A solution is made as follows: 23.97 g AAM (available for Sigma Aldrich, Milwaukee, Wis.), 455.03 g deionized water and 0.027 g GMA (available for Sigma Aldrich, Milwaukee, Wis.) are added to a reaction vessel which is sealed with a septa in 45° C. oven for 2 hours.

An Initiator Solution is prepared by adding 0.5044 g of VA-044 (available from Waco Chemicals, Waco, Tex.) to a 5 mL volumetric flask and diluting to 5 mL volume with deionized water.

Then the solution is removed from the oven. The solution is then sparged for 3 minutes with argon. After two minutes of sparging, 1 mL of initiator solution is added to the solution. Then continue heating at 45° C. for 16 hours to make the polymer solution.

b. Coating Articles with Monomers Capable of Forming a Soil Adsorbing Polymer

16 Albaad baby wipe substrates are conditioned at 21° C.±2° C. and a relative humidity of 50%±2% for 48 hours. After 48 hours, the equilibrated samples are weighed in subsets of 4 samples as recorded in Table 5 below labeled as initial weight.

A 0.02% solution of the polymer is prepared. 3.8 mL of the 0.02% solution of the polymer is added to each individual sample. The samples are air dried at 23° C.±2° C. and relative humidity less than 70% for 2 hours on plastic meshes. These samples are divided into 4 subsets of 4 samples each, here-in called 1, 2, 3 and 4.

Sample Subsets 1 and 2 are placed in a 60° C. oven for 16 hours. Sample Subsets 3 and 4 are kept at 23° C.±2° C. and relative humidity less than 70% conditions for 16 hours. All of the samples are then conditioned at 21° C.±2° C. and 50%±2% humidity for 16 hours to dry and equilibrate. After 16 hours the weights are recorded in Table 5 below as post treatment weights.

TABLE 5

| Sample | Sample Subset | Initial Weight | Post Treatment | Post Wash |
|---|---|---|---|---|
| 3A | 1 | 2.1815 | 2.1982 | 2.1879 |
| | 2 | 2.2540 | 2.2722 | 2.2608 |
| 3B | 3 | 2.0869 | 2.1115 | 2.0930 |
| | 4 | 2.1643 | 2.1911 | 2.1723 |

Sample Subsets 1 and 3 (listed as After Water Wash in Table 1) are washed with 400 mL of deionized water in a Büchner funnel. The Sample Subsets are then soaked in 400 mL of deionized water for 2 hours followed by washing with 400 mL of fresh deionized water in a Büchner funnel. The soak and wash is then repeated three more times.

Sample Subsets 2 and 4 (listed as After Bicarbonate Wash in Table 1) are washed with 400 mL of 1% aqueous sodium bicarbonate in a Büchner funnel. The Sample Subsets are then soaked in 400 mL of 1% aqueous sodium bicarbonate for 2 hours followed by washing with 400 mL of fresh of 1% aqueous sodium bicarbonate in a Büchner funnel. The soak and wash is then repeated two more times. The Sample Subsets are then soaked in 400 mL of deionized water for 2 hours followed by washing with 400 mL of fresh deionized water in a Büchner funnel.

All samples are then placed on a wire mesh and are then conditioned at 21° C.±2° C. and a relative humidity of 50%±2% for 16 hours. After 16 hours, the equilibrated Sample Subsets are weighed (reported in Table 5 above as the Post Wash weight).

The samples are then tested according to the Soil Adsorption Test Method described herein and the data is shown in Table 1 above.

### Example 4

### Grafting from (Bounty® Paper Towel)

a. Preparing Free Radical Generating Source—Azo Compound (4-(Trityldiazenyl)Benzoic Acid Chloride)

To a round bottom flask is added 4 g of 4-hydrazinylbenzoic acid (available from Sigma Aldrich, Milwaukee Wis.), 50 mL of N,N-dimethylformamide (DMF) (available from Sigma Aldrich, Milwaukee Wis.) and 91.6 mL diisopropylethylamine (available from Sigma Aldrich, Milwaukee Wis.). To this solution is added 7.7 g trityl chloride (available from Sigma Aldrich, Milwaukee Wis.) and the solution is stirred 24 h at 22 C under a calcium chloride (available from Sigma Aldrich, Milwaukee Wis.) drying tube. The solution is transferred to a separatory funnel and a 1:1 by volume solution of ethyl ether (available from Aldrich Chemical, Milwaukee, Wis., USA)/ethylacetate (available from Aldrich Chemical, Milwaukee, Wis., USA) (300 mL total) is added. The mixture is washed 3 times with 300 mL of 0.1M hydrochloric acid, once with 300 mL saturated sodium chloride solution and the organic layer is separated and dried (sodium sulfate). The solvent is removed in vacuo to provide the product as a red foam of 4-(2-tritylhydrazinyl)benzoic acid.

A solution of 2 g 4-(2-tritylhydrazinyl)benzoic acid in 130 mL acetic acid is stirred 16 hours at 21° C.±2° C. to ensure complete dissolution of the solid. To this solution is added 55 mg Magnesium/ethylene diamine tetraceticacid complex (available from Aldrich Chemical, Milwaukee, Wis., USA), 12 mg Sodium Tungstate (available from Aldrich Chemical, Milwaukee, Wis., USA) (dissolved in 1 mL water), and then 0.563 mL of hydrogen peroxide (available from Aldrich Chemical, Milwaukee, Wis., USA) (30% wt). The solution is stirred for 12 hours at 21° C.±2° C., and diluted with 150 mL ethyl acetate (available from Aldrich Chemical, Milwaukee, Wis., USA). Water is added and then the product is extracted into the organic phase. The solvent is removed in vacuo and the residue is purified by chromatography Silica (available from Aldrich Chemical, Milwaukee, Wis., USA), 5% methanol (available from Aldrich Chemical, Milwaukee, Wis., USA)/methylene chloride (available from Aldrich Chemical, Milwaukee, Wis., USA) to give the final product 4-(trityldiazenyl)benzoic acid (0.700 mg, 35%).

1.15 grams of 4-(trityldiazenyl)benzoic acid (from above) and 250 mL of anhydrous methylene chloride (available from Aldrich Chemical, Milwaukee, Wis., USA) are added to a pre-dried round bottom flask with an atmosphere of nitrogen sealed via septa. The solution is stirred and cooled to 0° C. After 10 minutes, 0.26 mL of oxalyl chloride (available from Aldrich Chemical, Milwaukee, Wis., USA) is added dropwise via syringe over a 10 minute period. After the addition is complete, 2 drops of anhydrous dimethylformamide (available from Aldrich Chemical, Milwaukee, Wis., USA) are added via syringe. The reaction is kept at 0° C. for an additional hour, and the solvents are removed via rotary evaporator under vacuum. The resulting yellow solid 4-(trityldiazenyl)benzoic acid chloride is kept under nitrogen atmosphere and used without further purification.

b. Durably Bonding Soil Adsorbing Polymer to Article

A Bounty® paper towel is cut into a 3 inch by 4 inch sample (approximate weight 0.35 grams) and placed in a 0% humidity chamber containing phosphorous pentoxide and allowed to dry for 24 hours. 0.5 grams of 4-(trityldiazenyl)benzoic acid chloride from above are dissolved in 20 mL of anhydrous dichloromethane (available from Aldrich Chemical, Milwaukee, Wis., USA), along with 1 mL of triethylamine (available from Aldrich Chemical, Milwaukee, Wis., USA) (“Azo solution”). After 24 hours of drying, the towel sample is placed in a pre-dried glass vessel and a septa cap is used to seal the glass vessel. The Azo solution is then injected thru the septa. The vessel is held in a 0° C. bath for 2 hours. After 2 hours, the reaction contents are removed and the sample is washed in a Büchner funnel with 100 mL of ethanol (available from Aldrich Chemical, Milwaukee, Wis., USA). The sample is then dried at 0° C. in vacuum to form an Azo functionalized sample (“a reactive article”).

1.73 grams of acrylamide (available from Aldrich Chemical, Milwaukee, Wis., USA), 0.004 grams of acrylic acid (available from Aldrich Chemical, Milwaukee, Wis., USA) and 0.026 grams of [3-(methacryloylamino)propyl]trimethylammonium chloride (50% aqueous solution) (available from Aldrich Chemical, Milwaukee, Wis., USA) are dissolved in 33.25 grams of water in a reaction vessel. The Azo functionalized sample (reactive article) from above is added to the monomer/water solution from above. This is degassed by bubbling with argon and the reaction vessel is immediately sealed and heated at 65° C. for 16 hours to form a durably bonded soil adsorbing sample. After 16 hours the durably bonded soil adsorbing sample is removed from the reaction vessel.

The durably bonded soil adsorbing sample is then soaked in 100 mL of deionized water for 2 hours. After 2 hours, the durably bonded soil adsorbing sample is filtered and rinsed in a Büchner funnel with 100 mL of fresh deionized water. The durably bonded soil adsorbing sample is then submerged and soaked for 2 hours in 100 mL of a 1% aqueous sodium bicarbonate solution in water and then filtered and rinsed in a Büchner funnel with 100 mL fresh 1% aqueous sodium bicarbonate solution. This procedure is repeated two additional times followed by soaking in 100 mL of deionized water and a final rinse with fresh 100 mL of deionized water. After the final rinse step, the durably bonded soil adsorbing sample is conditioned at 21° C.±2° C. and 50%±2% humidity for 48 hours to dry and equilibrate. After 48 hours the durably bonded soil adsorbing sample weight is recorded.

### Example 5

### Grafting from (VWR Cotton Pad)

a. Preparing Free Radical Generating Source—Periodate Compound

A solution of 6.8 g sodium meta-periodate (available from Aldrich Chemical, Milwaukee, Wis., USA) is dissolved in 2.0 g deionized water to form a Periodate Solution.

b. Durably Bonding Soil Adsorbing Polymer to Article

Eight pieces of VWR Cotton Pads Cat. No 21902-985 are conditioned at 21° C.±2° C. and 50%±2% humidity for 16 hours. After 16 hours the weight of the samples was recorded as 16.64 grams.

To a 2 gallon bucket is added 131.7 g acrylamide (AAM) (available from Aldrich Chemical, Milwaukee, Wis., USA), 2.0 g [3-(methacryloylamino)propyl]trimethylammonium chloride (50% solution) (available from Aldrich Chemical, Milwaukee, Wis., USA), 0.3 g acrylic acid (available from Aldrich Chemical, Milwaukee, Wis., USA), and 3190.0 g deionized water. The solution is placed in a vented laboratory oven and heated to 38° C. and then the Periodate Solution is added to the bucket.

The solution is then sparged with argon at 5 mL/second for 3 minutes. After 2 minutes of sparging, the samples are added to the solution. Sparging with argon is continued for 1 minute after the samples are added. Then the bucket is capped and placed in a 40° C. vented laboratory oven for 16 hours.

After 16 hours, the solution is decanted, the contents of the bucket are poured into a filter funnel. The samples (listed as After Water Wash in Table 1) are rinsed with 2 gallon of deionized water. The samples are placed into a 2 gallon bucket with 800 mL of deionized water. The samples are allowed to soak in this solution for 2 hours followed by a filtration and rinse with 400 mL of fresh deionized water in a Büchner funnel. The soak and rinse steps are repeated three more times. After the final rinse step, the samples are placed in a CTCH room at 21° C.±2° C. and 50%±2% humidity for 48 hours to dry and equilibrate. After 48 hours sample weight is recorded as 17.98 grams.

The samples which come as folded materials are unfolded and cut in half to produce approximately 12 square inch substrates. Four of the halved samples (listed as After Bicarbonate Wash in Table 1) are added to a 2 gallon container with 800 mL of a 1% w/v sodium bicarbonate solution. The samples are allowed to soak in this solution for 2 hours followed by a filtration and rinse with fresh 1% sodium bicarbonate solution in a Büchner funnel. The soak and rinse are repeated twice more with fresh 1% sodium bicarbonate solution. An additional soak and rinse using deionized water is performed. After the final rinse step, the samples are conditioned at 21° C.±2° C. and 50%±2% humidity for 48 hours to dry and equilibrate. After 48 hours sample weight is recorded, 4.303 grams.

The durably bonded soil adsorbing samples are then tested according to the Soil Adsorption Test Method described herein and the data is shown in Table 1 above.

### Example 6

### Grafting Through (Albaad Baby Wipe Substrates)

a. Preparing a Reactive Monomer

0.256 grams of a 50% solution of 1,1-diallyl-3-hydroxyazetidnium (synthesized in Example 2 above) is diluted to 500 mL volume with deionized water herein called Reactive Monomer Solution A.

b. Preparing Monomers Capable of Forming a Soil Adsorbing Polymer

9.9 grams of acrylamide (available from Sigma Aldrich Chemicals, Milwaukee, Wis.), 0.025 grams of acrylic acid (available from Sigma Aldrich Chemicals, Milwaukee, Wis.), 0.15 grams of [3-(methacryloylamino)propyl]trimethylammonium chloride (50% aqueous solution) (available from Sigma Aldrich Chemicals, Milwaukee, Wis.) and 238.925 grams of deionized water are combined in a reaction vessel and herein called Monomer Solution B.

c. Preparing Initiator Solution

0.52 g grams of 2,2′-azobis(2-methylpropionamidine) (available from Wako Chemicals, Richmond, Va. as V-50) is dissolved in 10 mL of water, herein called Initiator solution.

d. Durably Bonding Soil Adsorbing Polymer to Article

8 Albaad baby wipe substrates are cut to dimensions 3 inch×4 inch and then conditioned at 21° C.±2° C. and 50%±2% humidity for 2 hours. After conditioning the wipes are divided into 2 groups of 4 samples each as indicated in Table 6 below. The mass of each group is determined and recorded as shown in Table 6 below referred to as Pretreatment Mass.

TABLE 6

| | Pretreatment Mass | Post Monomer A | |
|---|---|---|---|
| Samples | (grams) | treatment (grams) | Final Masses (grams) |
| 1-4 | 2.0738 | 2.0882 | 2.1182 |
| 5-8 | 2.1407 | 2.1582 | 2.1988 |

Each group of samples is saturated with Reactive Monomer Solution A from above for 1 minute. Each group of samples is then placed on a rack until they stop dripping. After the substrates stop dripping they are then placed in a 50° C. oven for 1.5 hours. After 1.5 hours the substrates are removed from the oven and conditioned at 21° C.±2° C. and 50%±2% humidity for 2 hours. The substrates are weighed in groups of 4 and the results are reported in Table 6 above herein called Post Monomer A treatment. The substrates are then placed in the monomer solution B which has been preheated for 2.5 hours to 60° C. The solution is sparged for 3 minutes with argon. After 2 minutes of sparging, 1 mL of Initiator Solution is added. After 3 minutes of sparging the vessel is sealed and placed in a 60° C. ventilated laboratory drying oven for 16 hours.

After 16 hours the substrates are removed from the reaction vessel.

All substrates are then soaked in 800 mL of deionized water for 4 hours.

After 4 hours, the substrates are filtered and rinsed in a Büchner funnel with 800 mL of fresh deionized water. Substrates 1-4 (listed as After Bicarbonate Wash in Table 1) are soaked for two hours with 800 mL of a 1% aqueous sodium bicarbonate solution in water and then filtered and rinsed in a Büchner funnel with 800 mL fresh 1% aqueous sodium bicarbonate solution. This procedure is repeated three times followed by soaking and a final wash in deionized water.

Substrates 5-8 (listed as After Water Wash in Table 1) are soaked in 800 mL of fresh deionized water for 2 hours and then filtered and rinsed in a Büchner funnel with 800 mL fresh deionized water. This procedure is repeated 4 times.

All the substrates are conditioned at 21° C.±2° C. and 50%±2% humidity for 72 hours. The substrates are weighed in groups of 4 and the results are reported in Table 6 above as Final Mass.

The durably bonded soil adsorbing samples are then tested according to the Soil Adsorption Test Method described herein and the data is shown in Table 1 above.

### Example 7A-7D

### Grafting Through (Albaad Baby Wipe Substrates)

a. Preparing a Reactive Monomer

Two pre-treatment solutions, herein called PRE1 and PRE2, are made by combining glycidyl methacrylate, herein called GMA, (available from Sigma-Aldrich Chemical, Milwaukee, Wis., USA) and acetone (available from Sigma-Aldrich Chemical, Milwaukee, Wis., USA) in the amounts listed in Table 7 below.

TABLE 7

| Pre- | | | % |
|---|---|---|---|
| treatment | GMA | Acetone | active |
| solution | (g) | (mL) | GMA |
| PRE1 | 0.128 | 500 | 0.026% |
| PRE2 | 9.75 | 500 | 1.95% |

b. Preparing Monomers Capable of Forming a Soil Adsorbing Polymer

Four treatment solutions, herein called T1, T2, T3, & T4, are made by combining acrylamide, herein called AAM, (available from Sigma-Aldrich Chemical, Milwaukee, Wis., USA) and water in the amounts listed in Table 8 below. The solutions are warmed to approximately 50° C. in a laboratory drying oven.

TABLE 8

| Treatment | | |
|---|---|---|
| Solution | AAM | Water |
| T1 | 114 g | 1786 g |
| T2 | 57 g | 1843 g |
| T3 | 114 g | 1786 g |
| T4 | 57 g | 1843 g |

c. Preparing Initiator Solution

1 gram of 2,2′azobis(2-amidinopropane)dihydrochloride (available from Sigma Aldrich, Milwaukee, Wis., USA), is dissolved in deionized water to a total volume of 10 mL, herein called Initiator solution.

d. Durably Bonding Soil Adsorbing Polymer to Article

64 Albaad baby wipe substrates are cut to dimensions of 3 inch×4 inch to make 64 samples. The samples are then separated, 16 each, into 4 sample sets labeled A, B, C, & D respectively. The materials are then conditioned at 21° C.±2° C. and 50%±2% humidity for 2 hours and the mass of each sample set is obtained (initial conditioned sample set mass in Table 9 below). Every sample of each set is then treated with 3.8 mL of pre-treatment solution as indicated in Table 9 below. The samples are placed on a screen and allowed to air dry for 15 minutes in a fume hood. The samples are then placed in polyethylene bags by sample set and placed in a 50° C. laboratory drying oven for 1 hour.

The treatment solutions are removed from the laboratory drying oven and are sparged with argon for 3 minutes at a rate of approximately 5 mL/sec. After the first minute of sparging, 1 mL of Initiator Solution is added to each treatment solution. After the second minute of sparging, the sample sets are added to the treatment solutions as indicated in Table 9 below. After 3 minutes, the samples are sealed and placed back into a 50° C. vented laboratory drying oven for 16 hours.

After 16 hours each sample set is separately placed into 3 gallons of distilled water for 1 hour. After one hour, the water is drained and 3 gallons of fresh deionized water is added to each sample set. The samples are allowed to soak for 2 hours. This process is repeated 2 additional times. The samples are conditioned at 21° C.±2° C. and 50%±2% humidity for 12 hours to dry and equilibrate and the Final Mass is recorded in Table 9 below. Each sample set, of 16, is now divided into subsets of 8 samples labeled A1, A2, B1, B2, C1, C2, D1, and D2. The letter designation corresponds to the original set.

Subsets ending in 1 (listed as After Water Wash in Table 1) are placed into a container with 200 mL of deionized water. The samples are allowed to soak in this solution for 2 hours and then filtered and rinsed in a Büchner funnel with 200 mL of fresh deionized water. The soak and rinse are repeated three times. After the final rinse step, the samples are conditioned at 21° C.±2° C. and 50%±2% humidity for 48 hours to dry and equilibrate.

Subsets ending in 2 (listed as After Bicarbonate Wash in Table 1) are placed into a container with 200 mL of a 1% w/v aqueous sodium bicarbonate solution. The samples are allowed to soak in this solution for 2 hours and then filtered and rinsed in a Büchner funnel with 200 mL fresh 1% aqueous sodium bicarbonate solution. The soak and rinse are repeated twice more. The final soak and rinse uses deionized water. After the final rinse step, the samples are conditioned at 21° C.±2° C. and 50%±2% humidity for 48 hours to dry.

The durably bonded soil adsorbing samples are then tested according to the Soil Adsorption Test Method described herein and the data is shown in Table 1 above.

TABLE 9

| | Initial | | | |
|---|---|---|---|---|
| | Conditioned | Pre - | | |
| Sample | Sample Set | treatment | Treatment | Final |
| Set | Mass (g) | condition | Condition | Mass (g) |
| A | 8.189 | PRE2 | T1 | 8.562 |
| B | 8.318 | PRE2 | T2 | 8.532 |
| C | 8.380 | PRE1 | T3 | 10.377 |
| D | 8.561 | PRE1 | T4 | 9.648 |

### Example 8A-8B

### Grafting Through (Core 1 and Bounty® Paper Towel)

a. Preparing a Reactive Monomer

1.024 g glycidylmethacrylate (available from Sigma-Aldrich Chemical, Milwaukee, Wis., USA) and 4 L of acetone (available from Sigma-Aldrich Chemical, Milwaukee, Wis., USA) are combined, herein called GMA solution.

b. Preparing Monomers Capable of Forming a Soil Adsorbing Polymer

792.09 g acrylamide (available from Sigma-Aldrich Chemical, Milwaukee, Wis., USA), 11.98 g [3-(methacryloylamino)propyl]trimethyl ammonium chloride 50% aqueous solution (available from Sigma-Aldrich Chemical, Milwaukee, Wis., USA), 2.00 g acrylic acid (available from Sigma-Aldrich Chemical, Milwaukee, Wis., USA) and 794.05 g deionized water are placed into a separate container herein called the monomer solution.

c. Preparing Initiator Solution

10 g of 2,2′azobis(2-amidinopropane)di-hydro chloride (available from Sigma-Aldrich Chemical, Milwaukee, Wis., USA) and 100 mL of deionized water are placed into a separate container herein called the Initiator Solution.

d. Durably Bonding Soil Adsorbing Polymer to Article

A 270 gsm airlaid substrate (15% PE/PET bicomponent staple fibers/82% pulp fibers (i.e., SSK fibers), and 3% latex) (10 feet by 3.75 inches) (“Core 1”) and 21 full sheets of Bounty® paper towel are conditioned at 21° C.±2° C. and 50%±2% humidity for 2 hours. After two hours the masses of the samples are determined to be 81.3 grams for Core 1 and 77.2 grams for the Bounty® paper towel.

Each sample is added to its own 4 liters of the GMA solution and allowed to stand in the solution for approximately 5 minutes and then the excess fluid is decanted and a mass of the saturated samples are measured to be 522.01 grams for the Core 1 and 446.56 grams for the paper towel. The samples are placed on a screen and allowed to air dry for 16 hours. The samples are then placed into separate polypropylene bags and then placed in a 50° C. oven for 3.5 hours.

7203.2 grams deionized water and 460.8 grams of monomer solution are each added to two buckets and the buckets and contents are heated to 50° C. The GMA treated samples are then each added to a bucket containing the diluted monomer solution. The solution is purged with argon at the rate of 5 mL/sec for 4 minutes. During the 3rd minute of purging, 16 mL of the Initiator Solution is added to each bucket. The solution is capped after the argon purge and heating is maintained at 50° C. for 16 hours.

The contents of the buckets are poured into a filter funnel and the liquid portion is discarded. The solids are rinsed with 2 gallon of water. The samples are placed into a 2 gallon container with 800 mL of a 1% w/v sodium bicarbonate solution. The samples are allowed to soak in this solution for 2 hours and filtered and then rinsed with fresh 1% sodium bicarbonate solution in a Büchner funnel. The soak and rinse are repeated twice more. The final soak and rinse uses deionized water. After the final rinse step, the samples are conditioned at 21° C.±2° C. and 50%±2% humidity for 48 hours to dry and equilibrate. The samples masses are then measured to be 85.17 grams for Core 1 and 82.12 grams for the paper towel.

The durably bonded soil adsorbing sample is then tested according to the Soil Adsorption Test Method described herein and the data is shown in Table 1 above.

### Example 9A-9D

### Grafting Through (Core 2, MBCF 1, Albaad Baby Wipe Substrates, Terry Cloths)

a. Preparing a Reactive Monomer

1.024 g glycidylmethacrylate (available from Sigma-Aldrich Chemical, Milwaukee, Wis., USA) and 4 L of acetone (available from Sigma-Aldrich Chemical, Milwaukee, Wis., USA) are combined, herein called GMA solution.

b. Preparing Monomers Capable of Forming a Soil Adsorbing Polymer

792.09 g acrylamide (available from Sigma-Aldrich Chemical, Milwaukee, Wis., USA), 11.98 g [3-(methacryloylamino)propyl]trimethyl ammonium chloride 50% aqueous solution (available from Sigma-Aldrich Chemical, Milwaukee, Wis., USA), 2.00 g acrylic acid (available from Sigma-Aldrich Chemical, Milwaukee, Wis., USA) and 794.05 g deionized water are placed into a separate container herein called the monomer solution.

c. Preparing Initiator Solution

10 g of 2,2′azobis(2-amidinopropane)di-hydro chloride (available from Sigma-Aldrich Chemical, Milwaukee, Wis., USA) and 100 mL of deionized water are placed into a separate container herein called the Initiator Solution.

d. Durably Bonding Soil Adsorbing Polymer to Article

Core 2 (10 feet by 3.75 inches), MBCF 1 (27.5″ by 11″), LBAL (Albaad baby wipe substrates) (12 feet by 7 inches), and 8 terry cloths (6 inches×6 inches) are conditioned at 21° C.±2° C. and 50%±2% humidity for 2 hours. After two hours the masses of the samples are determined to be 27.9 grams for Core 2, 9.68 grams for MBCF 1, 43.59 grams for Albaad baby wipe substrates, and 357.98 grams for the terry cloths.

Each sample is added to its own 4 liters of the GMA solution and allowed to stand in the solution for approximately 5 minutes and then the excess fluid is decanted and a mass of the saturated samples are measured to be 249.57 grams for Core 2, 87.52 grams for MBCF 1, 241.50 grams for Albaad baby wipe substrate, and 1245.74 grams for the terry cloths. The samples are placed on a screen and allowed to air dry for 16 hours. The samples are then placed into separate polypropylene bags and then placed in a 50° C. oven for 3.5 hours.

10,804.8 grams deionized water and 691.2 grams of monomer solution are each added to four buckets and the buckets and contents are heated to 50° C. The GMA treated samples are then added to the diluted monomer solution. The solution is purged with argon at the rate of 5 mL/sec for 4 minutes. During the 3rd minute of purging, 24 mL of the Initiator Solution is added to each bucket. The solution is capped after the argon purge and heating is maintained at 50° C. for 16 hours.

The contents of the buckets are poured into a filter funnel and the liquid portion is discarded. The solids are rinsed with 2 gallon of water. The samples are placed into a 2 gallon container with 800 mL of a 1% w/v sodium bicarbonate solution. The samples are allowed to soak in this solution for 2 hours and filtered and then rinsed with fresh 1% sodium bicarbonate solution in a Büchner funnel. The soak and rinse are repeated twice more. The final soak and rinse uses deionized water. After the final rinse step, the samples are conditioned at 21° C.±2° C. and 50%±2% humidity for 48 hours to dry and equilibrate. The samples masses are then measured to be 28.92 grams for Core 2, 9.97 grams for MBCF 1, 44.80 grams for Albaad baby wipe substrates, and 381.98 grams for terry cloths.

The durably bonded soil adsorbing sample is then tested according to the Soil Adsorption Test Method described herein and the data is shown in Table 1 above.

### Example 10

### Grafting Through (MBCF 1)

a. Preparing a Reactive Monomer

0.116 g of glycidylmethacrylate (available from Sigma-Aldrich Chemical, Milwaukee, Wis., USA) and 500 mL of acetone (available from Sigma-Aldrich Chemical, Milwaukee, Wis., USA) are combined, herein called GMA solution.

b. Preparing Monomers Capable of Forming a Soil Adsorbing Polymer

47.2 g acrylamide (available from Sigma-Aldrich Chemical, Milwaukee, Wis., USA), 0.72 g [3-(methacryloylamino)propyl]trimethyl ammonium chloride 50% aqueous solution (available from Sigma-Aldrich Chemical, Milwaukee, Wis., USA), 0.12 g acrylic acid (available from Sigma-Aldrich Chemical, Milwaukee, Wis., USA) and 1552 g deionized water are placed into a separate container herein called the monomer solution.

c. Preparing Initiator Solution

0.70 g 2,2′azobis(2-amidinopropane)di-hydro chloride (available from Sigma-Aldrich Chemical, Milwaukee, Wis., USA) and 7 mL of deionized water are placed into a separate container herein called the Initiator Solution.

d. Durably Bonding Soil Adsorbing Polymer to Article

MBCF 1 [15 sheets (11″×11″)] are conditioned at 70° F.±2° F. and 50%±2% humidity for 2 hours. After two hours the mass of the samples is determined to be 26.58 grams.

The samples are added to 500 liters of GMA solution and allowed to stand in the solution for approximately 5 minutes and then the excess fluid is decanted. The samples are placed on a screen and allowed to air dry for 16 hours. The samples are then placed into a polypropylene bag and then placed in a 50° C. oven for 1.5 hours.

The samples are then conditioned at 21° C.±2° C. and 50%±2% humidity for 12 hours to dry and equilibrate. After 12 hours the weight is recorded as 26.97 grams.

The monomer solution is preheated to 60° C. and 3.2 mL of the Initiator Solution are added to the monomer solution. The GMA treated samples are added to the monomer solution. The solution is sparged at a rate of approximately 5 mL/second for 2 minutes. After two minutes the samples are added and sparging is continued for an additional 2 minutes. The solution is then brought to a temperature of approximately 50° C. and it is recorded and the container is sealed and the temperature is maintained at 50° C. for 16 hours.

The contents of the container are poured into a filter funnel and the liquid portion is discarded. The samples are rinsed with 400 mL of deionized water. The samples are placed into a 1 gallon container with 400 mL of a 1% w/v sodium bicarbonate solution. The samples are allowed to soak in this solution for 2 hours and filtered and then rinsed with fresh 1% sodium bicarbonate solution in a Büchner funnel. The soak and rinse are repeated twice more. The final soak and rinse uses deionized water. After the final rinse step, the samples are conditioned at 21° C.±2° C. and 50%±2% humidity for 48 hours to dry and equilibrate. The measured mass of the sample is 27.33 grams.

The durably bonded soil adsorbing samples are then tested according to the Soil Adsorption Test Method described herein and the data is shown in Table 1 above.

### Example 11A-11F

### Grafting Through (SP, PET/Nylon, MBCF 2, Albaad Baby Wipe Substrates, MBCF 1, Terry Cloths)

a. Preparing a Reactive Monomer

1.0296 grams of glycidyl methacrylate (GMA) (available from Sigma-Aldrich, Milwaukee, Wis.) is dissolved in 4 liters of acetone herein called the GMA solution.

b. Preparing Monomers Capable of Forming a Soil Adsorbing Polymer

495.05 grams of acrylamide (available from Sigma-Aldrich, Milwaukee, Wis.), 7.50 grams of the [3-(methacryloylamino)propyl]trimethylammonium chloride (50% solution) (available from Sigma-Aldrich, Milwaukee, Wis.) and 1.26 grams of acrylic acid (available from Sigma-Aldrich, Milwaukee, Wis.) are dissolved in 496.19 grams of water herein called monomer solution.

c. Preparing Initiator Solution

2.4 grams of 2,2′-azobis(2-methylproionamidine)dihydrochloride (available from Sigma-Aldrich, Milwaukee, Wis.) and 0.6 grams of 2,2′-azobis[2-methyl-N-(2-hydroxyethyl) propionamidine] (available from Wako Chemicals, Richmond, Va.) are dissolved in deionized water to a volume of 30 mL, herein called the Initiator Solution.

d. Durably Bonding Soil Adsorbing Polymer to Article

Each of the samples listed in Table 10 below are conditioned at 21° C.±2° C. and 50%±2% humidity for 16 hours to dry and equilibrate. After 16 hours the weights are recorded in Table 10 below as initial masses.

TABLE 10

| | | Post | | | |
|---|---|---|---|---|---|
| | Initial | treatment | Monomer | Heated | Initiator |
| | Mass | Mass | solution | water | solution |
| Sample | (grams) | (grams) | (grams) | (grams) | (mL) |
| Terry Cloth | 142.12 | 151.61 | 284.24 | 3261.36 | 7.4 |
| Albaad Baby | 32.87 | 34.02 | 65.77 | 754.53 | 1.71 |
| Wipe Substrate | | | | | |
| MBCF 2 | 15.75 | 16.31 | 31.52 | 361.67 | 0.82 |
| MBCF 1 | 27.07 | 28.04 | 54.17 | 621.43 | 1.41 |
| PET Nylon | 22.15 | 22.20 | 44.33 | 508.54 | 1.15 |
| SP | 15.49 | 15.68 | 30.96 | 355.24 | 0.81 |

The samples are saturated with the GMA solution for three minutes. The samples are then removed from the solution and allowed to drip dry until they stop dripping. After the samples stop dripping they are placed on a sheet of aluminum foil and allowed to air dry in a hood for 6 hours. After 6 hours, each of the samples is individually placed in a separate sealed polyethylene bag and placed in a 65° C. forced air laboratory drying oven for 72 hours. After 72 hours, the bags are removed from the oven and the samples are removed from the bags.

Next, 10 liters of deionized water is heated to 60° C. The monomer solution is also heated to 60° C. Six buckets are prepared for the six samples listed in Table 10 above. The amounts of water and monomer solution listed in Table 10 above are added to the appropriate buckets. The solutions are then sparged for 3 minutes with argon. After one minute of sparging, the amount of Initiator Solution according to Table 10 above is added with the samples to the corresponding buckets. The buckets are sealed and then heated for 16 hours at 60° C.

After 16 hours the temperature of the oven is raised to 70° C. After 2 hours, the buckets are removed from the oven and the samples are removed from their respective buckets.

The samples are soaked for two hours with 800 mL of a 1% aqueous sodium bicarbonate solution in deionized water and then filtered and rinsed in a Büchner funnel with 400 mL fresh 1% aqueous sodium bicarbonate solution. This procedure is repeated once followed by soaking for 16 hours in 800 mL of deionized water and a wash in 400 mL of fresh deionized water.

The 1% sodium bicarbonate soak and wash procedure is repeated 4 more times. The samples are then soaked in 800 mL of fresh 1% sodium bicarbonate solution for 16 hours and then washed with fresh 1% sodium bicarbonate solution. A final soak in 800 mL of deionized water for 2 hours followed by a wash in 400 mL of fresh deionized water is performed.

All the samples are air dried on a suspended wire screen for 6 hours and then conditioned at 21° C.±2° C. and 50%±2% humidity for 72 hours. The samples are weighed and the results are reported in Table 10 above as Post treatment mass.

The durably bonded soil adsorbing samples are then tested according to the Soil Adsorption Test Method described herein and the data is shown in Table 1 above.

### Example 12

### Grafting Through (Baby Wipe Substrates)

The baby wipe substrates (Baby Wipes A and Baby Wipes B) for this example come as a wet saturate in water (having been plasma treated by Brighton Technologies Group Inc., Cincinnati, Ohio) (13.56 MHz, approximately 150 mL/min O₂; pressure around 150 mTorr; 1 min. residence time). Baby wipe A (40/40/20 PET/PP/Cotton carded spunlace substrates—before lotioning) and Baby wipe B (40/40/20 PET/PP/Viscose carded spunlace substrates—before lotioning) (both from Suominen of Helsinki, Finland) are cut to dimensions of 3 inch×4 inch to make 12 samples of each (24 total samples).

a. Preparing a Reactive Monomer Solution

A reactive monomer pre-treatment solution is made by combining 0.2574 g glycidyl methacrylate, herein called GMA, (available from Sigma-Aldrich Chemical, Milwaukee, Wis., USA) and 1 L acetone (available from Sigma-Aldrich Chemical, Milwaukee, Wis., USA).

b. Preparing a Monomer Solution Capable of Forming a Soil Adsorbing Polymer

A monomer treatment solution is made by combining 15.84 g acrylamide, herein called AAM, (available from Sigma-Aldrich Chemical, Milwaukee, Wis., USA), 0.24 g MAPTAC (50%), 0.05 g acrylic acid, and 303.89 g water. The solution is capped and gently warmed to 60° C. over the course of approximately 2 hours.

c. Preparing Initiator Solution

0.80 g of 2,2′-azobis(2-amidinopropane)dihydrochloride (V-50) (available from Sigma Aldrich, Milwaukee, Wis., USA) and 0.20 g 2,2′-azobis(2-methyl-N-(2-hydroxyethyl) propionamide) (VA-086), is dissolved in deionized water to a total volume of 10 mL, herein called Initiator Solution.

d. Preparing 1% Sodium Bicarbonate Wash Solution

100 g of sodium bicarbonate (available from Sigma-Aldrich Chemical, Milwaukee, Wis., USA) is added to 9900 g water to make a solution that is 1% sodium bicarbonate by total mass.

e. Durably Bonding Soil Adsorbing Polymer to Article

The substrates are then conditioned at 21° C.±2° C. and 50%±2% humidity for 2 hours and then the mass of the substrates are determined in sets of 4 substrates (see Table 11 below, equilibrated mass). Sets 3 and 6 are untreated and used as comparative samples. Fully saturate substrate sets 1, 2, 4, and 5 in the reactive monomer solution and allow to stay submerged in the reactive monomer solution for 1 minute. After soaking, the substrates are placed on a wire mesh in a fume hood to allow any excess reactive monomer solution to drain and to come to dryness for a time of 2 hours. The substrates are then placed in polyethylene bags according to each set number, sealed, and placed in a 60° C. laboratory oven for 1.5 hours.

The substrates are removed from the oven, cooled, and then removed from the bags. The heated Monomer Solution Capable of Forming a Soil Adsorbing Polymer is sparged with inert gas for 3 minutes at a rate of approximately 5 mL/sec. After the first minute of sparging, 0.67 mL of Initiator Solution is added to the Monomer Solution Capable of Forming a Soil Adsorbing Polymer. After the second minute of sparging, sample sets 1, 2, 4, and 5 are added collectively to the treatment solution. After 3 minutes sparging, the substrates in the Monomer Solution Capable of Forming a Soil Adsorbing Polymer are sealed and placed into a 60° C. laboratory oven for 16 hours.

After 16 hours the substrate sets 1, 2, 4, and 5 are taken out of the laboratory oven and cooled to 21° C. and are then placed into 800 mL of distilled water for 4 hours. After the 4 hours, the water slurry is drained and the substrates are washed according to Table 11 below.

f. Washing Method A (Listed as after Bicarbonate Wash in Table 1) for Sample Sets 1 and 4

A substrate set of 4 substrates is soaked in 800 mL of 1% sodium bicarbonate solution for 2 hours. After this soak the substrate set is then drained of the solution using a Büchner funnel wide enough to keep the 4 stacked substrates flat and then the substrate set is rinsed with 400 mL of the 1% sodium bicarbonate solution while the substrates remain inside the funnel. This process is repeated 2 additional times for a total of 3 bicarbonate soaks and rinses. Then, the substrate set is soaked in 800 mL of deionized water for 2 hours. After this soak, the substrate set is then drained of the solution using a Büchner funnel wide enough to keep the 4 stacked substrates flat and then the substrate set is rinsed with 400 mL of deionized water while the substrates remain inside the funnel. The moist substrates are allowed to air dry on a plastic or wire mesh lattice for 1 hour and are then conditioned at 21° C.±2° C. and 50%±2% humidity for 24 hours.

g. Washing Method B (Listed as after Water Wash in Table 1) for Sample Sets 2 and 5

A substrate set of 4 substrates is soaked in 800 mL of deionized water for 2 hours. After this soak the substrate set is then drained of the solution using a Büchner funnel wide enough to keep the 4 stacked substrates flat and then the substrate set is rinsed with 400 mL of deionized water while the substrates remain inside the funnel. This process is repeated 3 additional times for a total of 4 water soaks and rinses. The moist substrates are allowed to air dry on a plastic or wire mesh lattice for 1 hour and are then conditioned at 21° C.±2° C. and 50%±2% humidity for 24 hours.

h. Soil Adsorption Testing of Substrates

After washing, the substrates are tested according to the Soil Adsorption Test Method described herein and the Soil Adsorption Values are shown in Table 1 above.

TABLE 11

| | | Equilibrated | Washing | Final Mass |
|---|---|---|---|---|
| Substrate | Set | Mass (g) | Method | (g) |
| Baby Wipes | 1 | 1.7893 | A | 1.8783 |
| A (1-4) | | | | |
| Baby Wipes | 2 | 1.8815 | B | 1.9189 |
| A (5-8) | | | | |
| Baby Wipes | 3 | 1.8678 | — | 1.8678 |
| A (9-12) | | | | |
| Baby Wipes | 4 | 1.3619 | A | 1.3905 |
| B (1-4) | | | | |
| Baby Wipes | 5 | 1.3786 | B | 1.4088 |
| B (5-8) | | | | |
| Baby Wipes | 6 | 1.4159 | — | 1.4159 |
| B (9-12) | | | | |

### Example 13

### Grafting Through Using Fibrella 2000 (67% Viscose/33% PET) Substrates

a. Preparing a Reactive Monomer Solution

A reactive monomer pre-treatment solution is made by combining 0.2574 g glycidyl methacrylate, herein called GMA, (available from Sigma-Aldrich Chemical, Milwaukee, Wis., USA) and 1 L acetone (available from Sigma-Aldrich Chemical, Milwaukee, Wis., USA).

b. Preparing a Monomer Solution Capable of Forming a Soil Adsorbing Polymer

A monomer treatment solution is made by combining 24.75 g acrylamide, herein called AAM, (available from Sigma-Aldrich Chemical, Milwaukee, Wis., USA), 0.375 g [3-(methacryloylamino)propyl]trimethylammonium chloride (available as a 50% aqueous solution from Sigma-Aldrich, Milwaukee, Wis.), 0.0625 g acrylic acid (available from Sigma-Aldrich, Milwaukee, Wis.), and 24.8125 g water.

c. Preparing Initiator Solution

0.80 g of 2,2′-azobis(2-amidinopropane)dihydrochloride (V-50) (available from Sigma Aldrich, Milwaukee, Wis., USA) and 0.20 g 2,2′-azobis(2-methyl-N-(2-hydroxyethyl) propionamide) (VA-086), is dissolved in deionized water to a total volume of 10 mL, herein called Initiator Solution.

d. Preparing 1% Sodium Bicarbonate Wash Solution

100 g of sodium bicarbonate (available from Sigma-Aldrich Chemical, Milwaukee, Wis., USA) is added to 9900 g water to make a solution that is 1% sodium bicarbonate by total mass.

e. Durably Bonding Soil Adsorbing Polymer to Article

A Fibrella substrate is conditioned as received at 21° C.±2° C. and 50%±2% humidity for 2 hours and then the mass of the substrate is determined and recorded (equilibrated mass) in Table 12 below. Fully saturate the substrate in the reactive monomer solution and allow to stay submerged in the reactive monomer solution for 1 minute. After soaking, the substrate is placed on a wire mesh in a fume hood to allow any excess reactive monomer solution to drain and to come to dryness for a time of 2 hours. The substrate is then placed in a polyethylene bag, sealed, and placed in a 60° C. laboratory oven for 1.5 hours.

The substrate is removed from the oven, cooled to 21° C., and then removed from the bag. To a reaction vessel add 24.88 g of the heated Monomer Solution Capable of Forming a Soil Adsorbing Polymer and 285.48 g of pre-warmed 70° C. deionized water to make a mixture. The mixture is then sparged with inert gas for 3 minutes at a rate of approximately 5 mL/sec. After the first minute of sparging, 0.65 mL of Initiator Solution is added to the mixture. After the second minute of sparging, the GMA treated Fibrella substrate is added to the mixture. After 3 minutes sparging is ceased and the reaction vessel is sealed with the substrate in it. The reaction vessel is then placed into a 60° C. laboratory oven for 48 hours.

After 48 hours, the laboratory oven is set to 70° C. and the reaction vessel is allowed to continue to warm for an additional 2 hours. Afterwards, the reaction vessel is removed from the oven and allowed to cool to 21° C. The contents of the reaction vessel are then removed discarding as much of the fluid layer as possible by allowing the contents to drain via a Büchner funnel. The contents are then placed into 800 mL of deionized water for 4 hours. After the 4 hours, the water slurry is drained and the substrate is washed according to Washing Method C set forth below.

g. Washing Method C

The treated Fibrella substrate is soaked in 800 mL of 1% sodium bicarbonate solution for 2 hours. After this soak the substrate is then drained of the solution using a Büchner funnel and then the substrate is rinsed with 400 mL of 1% sodium bicarbonate solution while the substrate remains inside the funnel. This process is repeated 2 additional times for a total of 3 sodium bicarbonate soaks and rinses. Then, the Fibrella substrate is soaked in 800 mL of deionized water for 2 hours. After this soak, the substrate is then drained of the solution using a Büchner funnel and then the substrate is rinsed with 400 mL of deionized water while the substrate remains inside the funnel. The moist substrate is allowed to air dry on a plastic or wire mesh lattice for 1 hour and is then conditioned at 21° C.±2° C. and 50%±2% humidity for 24 hours. After the 24 hours, the mass of the substrate is taken and recorded (final mass) in Table 12 below.

h. Soil Adsorption Testing of Substrate

After washing, the substrate is tested according to the Soil Adsorption Test Method described herein and the Soil Adsorption Values are shown in Table 1 above.

TABLE 12

| | Equilibrated | |
|---|---|---|
| Substrate | Mass (g) | Final Mass (g) |
| Treated Fibrella | 6.2202 | 6.7777 |

### Example 14

### O-Cel-O™ Sponge

a. Preparing a Reactive Monomer Solution

A reactive monomer pre-treatment solution is made by combining 1.008 g glycidyl methacrylate, herein called GMA, (available from Sigma-Aldrich Chemical, Milwaukee, Wis., USA) and 4 L acetone (available from Sigma-Aldrich Chemical, Milwaukee, Wis., USA).

b. Preparing a Monomer Solution Capable of Forming a Soil Adsorbing Polymer

A monomer treatment solution is made by combining 148.5 g acrylamide, herein called AAM, (available from Sigma-Aldrich Chemical, Milwaukee, Wis., USA), 2.278 g [3-(methacryloylamino)propyl]trimethylammonium chloride (available as a 50% aqueous solution from Sigma-Aldrich, Milwaukee, Wis.), 0.374 g acrylic acid (available from Sigma-Aldrich, Milwaukee, Wis.), and 148.648 g water.

c. Preparing Initiator Solution

1.032 g of 2,2′-azobis(2-amidinopropane)dihydrochloride (V-50) (available from Sigma Aldrich, Milwaukee, Wis., USA is dissolved in deionized water to a total volume of 10 mL, herein called Initiator Solution.

d. Preparing 1% Sodium Bicarbonate Wash Solution

100 g of sodium bicarbonate (available from Sigma-Aldrich Chemical, Milwaukee, Wis., USA) is added to 9900 g water to make a solution that is 1% sodium bicarbonate by total mass.

e. Durably Bonding Soil Adsorbing Polymer to Article

O-Cel-O™ sponge substrate (available from 3M) is conditioned as received at 21° C.±2° C. and 50%±2% humidity for 16 hours and then the mass of the substrate is determined and recorded (equilibrated mass) in Table 13. Fully saturate the substrate in the reactive monomer solution and allow to stay submerged in the reactive monomer solution for 1 minute. After soaking, the substrates are placed on a wire mesh in a fume hood to allow any excess reactive monomer solution to drain and to come to dryness for a time of 2 hours. The substrate is then placed in a polyethylene bag, sealed, and placed in a 50° C. laboratory oven for 1.5 hours.

The substrate is removed from the oven, cooled to ambient, and then removed from the bag. To a reaction vessel add 299.8 g of Monomer Solution Capable of Forming a Soil Adsorbing Polymer and 2693.8 g of pre-warmed 70° C. water. This solution is sparged with inert gas for 4 minutes 30 seconds at a rate of approximately 10 mL/sec. After the first minute of sparging, 6.25 mL of Initiator Solution is added to the mixture and temperature of the solution found to be approximately 56° C. After the second minute of sparging, the GMA treated O-Cel-O™ sponge substrates are added to the mixture and are gently pressed to remove entrapped gasses. After 4 minutes and 30 seconds, sparging is ceased and the vessel sealed. The vessel and contents are placed into a 55° C. laboratory oven for 16 hours.

Afterwards, the substrate is removed from the laboratory oven. The contents are then removed discarding as much of the fluid layer as possible by allowing the contents to drain via Büchner funnel. The contents are then placed into 2.5 gallons of deionized water for 2 hours. After the 2 hours, the water slurry is drained and the substrates are washed according to washing method D.

TABLE 13

| | Equilibrated | |
|---|---|---|
| | Starting Mass | Final |
| Material | (g) | Mass (g) |
| O-Cel-O | 24.40 | 24.53 |

f. Washing Method D

O-Cel-O™ sponge substrate is soaked in ½ gallon of 1% sodium bicarbonate solution for 2 hours. After this soak the substrate is then drained of the solution using a Büchner funnel and then the substrate is rinsed with ½ gallon of the 1% sodium bicarbonate solution while the substrates remain inside the funnel. The sponge is then soaked an additional time in fresh ½ gallon of 1% sodium bicarbonate solution for 2 hours. After this soak the substrate is then drained of the solution using a Büchner funnel and then the substrate is rinsed with ½ gallon of deionized water. Then, the substrate is soaked in ½ gallon of deionized water for 2 hours. After this soak, the substrate is then drained of the solution using a Büchner funnel and then the substrate is rinsed with 1 gallon of deionized water while the substrate remains inside the funnel. The moist substrate is allowed to air dry on a plastic or wire mesh lattice and allowed to dry in a conditioned room at 21° C.±2° C. and 50%±2% humidity for 24 hours. After 24 hours the mass of the substrate is taken and recorded (final mass) in Table 13 above.

g. Soil Adsorption Testing of Substrates

Each O-Cel-O™ sponge is sliced into 3 pieces of thickness 2.75 mm each. After washing, the substrates are tested according to the Soil Adsorption Test Method described herein and the Soil Adsorption Values are shown in Table 1 above.

### Example 15

### Entanglement Example (Cerium Compound)

a. Preparing Monomers Capable of Forming a Soil Adsorbing Polymer

23.76 g of Acrylamide (available from Sigma-Aldrich, Milwaukee, Wis.), 0.36 grams of [3-(methacryloylamino)propyl]trimethylammonium chloride (available as a 50% aqueous solution from Sigma-Aldrich, Milwaukee, Wis.)) and 0.07 grams of acrylic acid (available from Sigma-Aldrich, Milwaukee, Wis.) are added to a reaction vessel.

Then 0.264 grams of Ammonium Cerium Nitrate (available from Sigma-Aldrich, Milwaukee, Wis.), 1.920 mL of 1N Nitric acid (available from Sigma-Aldrich, Milwaukee, Wis.), and 453.62 g water are added to the reaction vessel and the reaction vessel is sealed.

b. Entangling Soil Adsorbing Polymer with Article

12 Albaad baby wipe substrates (3 inch×4 inch) are conditioned at 21° C.±2° C. and a relative humidity of 50%±2% for two hours. After 2 hours, the equilibrated samples are weighed (6.201 g).

The reaction vessel is placed into a 40° C. oven for 45 minutes. The reaction vessel is removed from the oven and the weighed samples are placed in the reaction vessel with the monomer solution and sparged with argon for 3 minutes. The reaction vessel is sealed and returned to the 40° C. oven for 16 hours.

After 16 hours the reaction vessel is removed from the oven and the samples are removed from the reaction vessel.

The samples are placed into 1 gallon bucket and 1500 mL of deionized water is added. The bucket is gently agitated by hand for 10 minutes to remove loose polymer from the samples. The samples are then carefully removed from this solution, separated into individual samples, and placed into a gallon glass jar with 2000 mL of deionized water to soak. The samples are gently agitated by hand and then allowed to soak overnight for 16 hours.

After 16 hours, the samples are removed from the glass jar and washed with 1000 mL of deionized water in a Büchner funnel four times. Between each rinse in the Büchner funnel, the samples are soaked in 1500 mL of deionized water for 2 hours. The samples are then once more placed in 1500 mL of deionized water and allowed to soak for 64 hours.

After the 64 hours, the samples are divided into 3 subsets of 4 samples each (A, B, C). All of the samples are conditioned at 21° C.±2° C. and a relative humidity of 50%±2% for two hours. After 2 hours, the equilibrated subsets are weighed (reported in Table 14 below as the starting weight).

TABLE 14

| Sample Subset | Starting Weight | Final Weight |
|---|---|---|
| A | 3.674 | — |
| B | 3.431 | 3.428 |
| C | 3.399 | 3.395 |

Sample Subset A is not subjected to washing steps that Sample Subsets B and C are subjected to.

Sample Subset B (listed as After Water Wash in Table 1) is washed with 200 mL of deionized water in a Büchner funnel. Sample Subset B is then soaked in 200 mL of deionized water for 2 hours followed by washing with 200 mL of fresh deionized water in a Büchner funnel. The soak and wash is then repeated three more times.

Sample Subset C (listed as After Bicarbonate Wash in Table 1) is washed with 200 mL of 1% aqueous sodium bicarbonate in a Büchner funnel. Sample Subset C is then soaked in 200 mL of 1% aqueous sodium bicarbonate for 2 hours followed by washing with 200 mL of fresh 1% aqueous sodium bicarbonate in a Büchner funnel. The soak and wash is then repeated two more times. Sample Subset C is then soaked in 200 mL of deionized water for 2 hours followed by washing with 200 mL of fresh deionized water in a Büchner funnel.

Subsets B and C are then placed on a wire mesh and are then conditioned at 21° C.±2° C. and a relative humidity of 50%±2% for 16 hours. After 16 hours, the equilibrated Sample Subsets are weighed (reported in Table 14 above as the final weight).

The entangled soil adsorbing samples B and C are then tested according to the Soil Adsorption Test Method described herein and the data is shown in Table 1 above.

### Example 16

### Entanglement Example (Azo Compound)

a. Preparing Monomers Capable of Forming a Soil Adsorbing Polymer

23.76 grams of Acrylamide (available from Sigma-Aldrich, Milwaukee, Wis.), 0.37 grams of 3-(methacryloylamino)propyl]trimethylammonium chloride (available as a 50% aqueous solution from Sigma-Aldrich, Milwaukee, Wis.), 0.07 grams of acrylic acid (available from Sigma-Aldrich, Milwaukee, Wis.) and 454.80 grams of water are added to a reaction vessel and the reaction vessel is sealed. The reaction vessel is placed into a 40° C. oven for 45 minutes.

b. Preparing Initiator Solution

An Initiator Solution is prepared by adding 2.50165 g of VA-044 (available from Waco Chemicals, Waco, Tex.) to a 25 mL volumetric flask and diluting with 25 mL water.

c. Entangling Soil Adsorbing Polymer with Article

12 Albaad baby wipe substrates are conditioned at 21° C.±2° C. and a relative humidity of 50%±2% for two hours. After 2 hours, the equilibrated samples are weighed (6.184 g).

The reaction vessel is removed from the oven and 1 mL of the 10% Initiator Solution is added. The solution is then sparged for 3 minutes with argon. After two minutes of sparging, the samples are placed in the reaction vessel with the solution and sparged with argon for 1 minute. The reaction vessel is sealed and returned to the 40° C. oven. After 16 hours the reaction vessel is removed from the oven and the samples are removed from the reaction vessel.

The samples are placed into 1 gallon bucket and 1500 mL of deionized water is added. The bucket is gently agitated by hand for 10 minutes to remove loose polymer from the samples. The samples are then carefully removed from this solution, separated into individual samples, and placed into a gallon glass jar with 2000 mL of deionized water to soak. The samples are gently agitated by hand and then allowed to soak overnight for 16 hours.

After 16 hours, the samples are removed from the glass jar and washed with 1000 mL of deionized water in a Büchner funnel four times. Between each rinse in the Büchner funnel, the samples are soaked in 1500 mL of deionized water for 2 hours. The samples are then once more placed in 1500 mL of deionized water and allowed to soak for 64 hours.

After the 64 hours, the samples are divided into 3 subsets of 4 samples each (A, B, C). All of the samples are conditioned at 21° C.±2° C. and a relative humidity of 50%±2% for two hours. After 2 hours, the equilibrated subsets are weighed (reported in Table 15 below as the starting weight).

TABLE 15

| Subset | Starting Weight | Final Weight |
|---|---|---|
| A | 2.178 | — |
| B | 2.157 | 2.155 |
| C | 2.181 | 2.134 |

Sample Subset A is not subjected to washing steps that Sample Subsets B and C are subjected to.

Sample Subset B (listed as After Water Wash in Table 1) is washed with 200 mL of deionized water in a Büchner funnel. Sample Subset B is then soaked in 200 mL of deionized water for 2 hours followed by washing with 200 mL of fresh deionized water in a Büchner funnel. The soak and wash is then repeated three more times.

Sample Subset C (listed as After Bicarbonate Wash in Table 1) is washed with 200 mL of 1% aqueous sodium bicarbonate in a Büchner funnel. Sample Subset C is then soaked in 200 mL of 1% aqueous sodium bicarbonate for 2 hours followed by washing with 200 mL of fresh 1% aqueous sodium bicarbonate in a Büchner funnel. The soak and wash is then repeated two more times. Sample Subset C is then soaked in 200 mL of deionized water for 2 hours followed by washing with 200 mL of fresh deionized water in a Büchner funnel.

Subsets B and C are then placed on a wire mesh and are then conditioned at 21° C.±2° C. and a relative humidity of 50%±2% for 16 hours. After 16 hours, the equilibrated Sample Subsets are weighed (reported in Table 15 above as the final weight).

The entangled soil adsorbing samples B and C are then tested according to the Soil Adsorption Test Method described herein and the data is shown in Table 1 above.

### Comparative Examples

### Non-Durably Bonded and Non-Entangled Soil Adsorbing Articles

### Comparative Examples 1A-1C

### Albaad Baby Wipe Substrates

a. Preparing Initiator Solution

The quantities, listed in Table 16 below, of initiator ammonium cerium(IV) nitrate (available from Aldrich Chemical, Milwaukee, Wis., USA), and nitric acid (available as 15.7 molar solution, from Aldrich Chemical, Milwaukee, Wis., USA) are placed into a volumetric flask and deionized water is added to bring the total volume to the amount also listed in Table 16 below.

TABLE 16

| | | | | Total |
|---|---|---|---|---|
| | | | Nitric Acid | volume |
| | | Nitric Acid | Amount used | initiator |
| | | Concentration | in Reaction | solution |
| Example | Initiator (g) | Used (Molar) | (mL) | (mL) |
| 1-1 | 0.274 | 1.0 | 4.00 | 10 |
| 1-2 | 0.027 | 1.0 | 0.200 | 50 |
| 1-3 | 0.274 | 15.7 | 0.255 | 100 |

b. Contacting Articles with Monomers Capable of Forming a Soil Adsorbing Polymer

Three polymerizations are run as follows: The monomers acrylamide (AAM), (available from Sigma Aldrich, Milwaukee Wis., USA), [3-(methyacryloylamino)propyl]trimethylammonium chloride] (MAPTAC) available as a 50% by mass solution in water from Sigma Aldrich, Milwaukee Wis., USA) and acrylic acid (AA), available from Sigma Aldrich, Milwaukee Wis., USA) as noted in Table 17 below are placed into a 1 liter plastic container with lid. Additional deionized water, also noted in Table 17, is then added. The container is capped and placed in a vented laboratory drying oven set at 40° C. for 2 hours. After the 2 hours, the container is removed temporarily from the oven and the contents of the respective Initiator Solution as indicated in Table 16 are added. The final solutions, as listed in Table 18, are sparged with argon for 2 minutes.

TABLE 17

| | | 50% | | |
|---|---|---|---|---|
| | | MAPTAC | | Additional |
| Example | AAM (g) | (g) | AA (g) | water (g) |
| 1-1 | 4.925 | 0.077 | 0.012 | 485.0 |
| 1-2 | 24.750 | 0.381 | 0.063 | 424.8 |
| 1-3 | 2.475 | 0.037 | 0.008 | 397.5 |

TABLE 18

| Relative Monomer Compostion | | | | Solution Compostion assuming density - 1 g/mL | | | | |
|---|---|---|---|---|---|---|---|---|
| | | | | Sum of | | | | Total |
| | | | | reaction | Monomer | | | Fabric |
| | AAM | MAPTAC | AA | solvent | Concentration | (NH₄)₂Ce(NO₂)₆ | HNO₃ | Mass |
| Example | % | % | % | mass (g) | (%) | Molarity | Molarity | (g) |
| 1-1 | 98.98% | 0.77% | 0.25% | 500 | 1.0% | 1.00E−03 | 8.00E−03 | 10.44 |
| 1-2 | 98.99% | 0.76% | 0.25% | 500 | 5.0% | 1.00E−04 | 4.00E−04 | 10.29 |
| 1-3 | 98.94% | 0.74% | 0.32% | 500 | 0.5% | 1.00E−03 | 8.01E−03 | 10.05 |

After the first minute of sparging sheets of 65 gsm airlaid substrates (available from Albaad USA (Reidsville, N.C.) 70% pulp fibers with 30% latex/polypropylene binder), which have been cut to 3 inch by 4 inch dimensions with 20 samples per reaction condition are added. The sheets have already been conditioned at 21° C.±2° C. and a relative humidity of 50%±2% as single sheets on suspended wire screen for 24 hours. The collective mass of the samples per condition prior to contacting the monomer solution is taken and recorded (starting fabric mass) in Table 19 below. 20 sheets of the samples are placed in each container being careful not to crease the sheets while sparging continues. After the 2 minutes of sparging, the container is sealed and placed back into the oven at 40° C. for 16 hours.

The containers are then removed from the oven after 16 hours and the samples are removed from the containers. The solution is decanted from the containers. The sets of 20 sheets are rinsed 3 times with 500 mL each of deionized water, then covered in 500 mL deionized water and allowed to soak for 7 hours. A Büchner funnel is set up with an aspirator and samples are washed 5 times, 5 at a time with 50 mL of deionized water. The samples are then again conditioned at 21° C.±2° C. and a relative humidity of 50%±2% for 24 hours in the same method used to obtain initial mass. The final samples mass is obtained after conditioning (ending fabric mass) and the initial mass and final mass are listed in Table 19 below.

Next, four sheets of each treatment are then soaked in 100 mL of 1% sodium bicarbonate solution for 2 hours. After this soak, the substrate is then drained of the solution using a Büchner funnel and then the substrate is rinsed with 50 mL of fresh 1% sodium bicarbonate solution while the substrate remains inside the Büchner funnel. This process is repeated two additional times for a total of three sodium bicarbonate solution soaks and rinses. Then the treated substrates are soaked in 100 mL of deionized water for 1 hour. After this soak, the substrate is drained of the deionized water using a Büchner funnel and then the substrate is rinsed with 50 mL of fresh deionized water while the substrate remains inside the Büchner funnel. The moist substrate is allowed to air dry on a plastic or wire mesh lattice for 1 hour and is then conditioned at 21° C.±2° C. and a relative humidity of 50%±2% for 24 hours.

TABLE 19

| Sample | Subset | Starting Fabric Mass (g) | Ending Fabric Mass (g) |
|---|---|---|---|
| 1A | 1-1 | 10.44 | 11.08 |
| 1B | 1-2 | 10.29 | 10.35 |
| 1C | 1-3 | 10.05 | 10.27 |

The samples are then tested according to the Soil Adsorption Test Method described herein and the data is shown in Table 1 above. From the data, it is clear that these comparative samples are not within the scope of the durably bonded soil adsorbing articles or entangled soil adsorbing articles of the present invention.

### Comparative Examples 2A-2B

### Albaad Baby Wipe Substrates

Coating Articles with Monomers Capable of Forming a Soil Adsorbing Polymer

Into a reaction vessel add acrylamide (23.76 g), acrylic acid (0.06 g), 3-(methyacryloylamino)propyl]trimethylammonium chloride 50% (0.36 g), (all available from Sigma Aldrich) and 456 g of water. The reaction vessel is sparged with argon to remove oxygen from the system and an argon atmosphere is maintained in the vessel. The reaction vessel and contents are heated to a temperature of 60° C. Once the contents have reached 60° C., 1 mL of an aqueous 10% solution of 2,2-azobis(2-methylpropionamidine)dihydrochloride (available from Wako Chemicals, Richmond, Va.) is added to the vessel and the reaction kept at 60° C. for 48 hours to form a polymer solution.

A 2% solution of the polymer solution is made called Solution A and a 0.02% solution of the polymer solution is made called Solution B.

16 Pampers® Thick Care baby wipes (3 inch×4 inch) are conditioned at 21° C.±2° C. and a relative humidity of 50%±2% for 48 hours. After 48 hours, the equilibrated samples are weighed in subsets of 4 samples as recorded in Table 20 below labeled as initial mass.

TABLE 20

| | | Post treatment | Post Wash |
|---|---|---|---|
| Sample ID | Initial Mass | Mass | weight |
| A-1 | 2.046 | 2.205 | — |
| A-2 | 2.081 | 2.244 | 2.106 |
| B-1 | 2.072 | 2.100 | — |
| B-2 | 2.008 | 2.035 | 2.026 |

Samples from Sample Subsets A-1 and A-2 are treated with 1.6 mL of solution A. Samples from Sample Subsets B-1 and B-2 are treated with 3.8 mL of solution B. The samples are air dried at 23°±2° C. and relative humidity less than 70% for 12 hours on plastic meshes. Weights are then recorded as post treatment mass in Table 20 above.

Sample Subsets ending in -1 (listed as After Water Wash but prior to the water wash in Table 1) are tested as is.

Sample Subsets ending in -2 (listed as After Bicarbonate Wash in Table 1) are washed with 400 mL of 1% aqueous sodium bicarbonate in a Büchner funnel. The Sample Subsets are then soaked in 400 mL of 1% aqueous sodium bicarbonate for 2 hours followed by washing with 400 mL of fresh of 1% aqueous sodium bicarbonate in a Büchner funnel. The soak and wash is then repeated two more times. The Sample Subsets are then soaked in 400 mL of deionized water for 2 hours followed by washing with 400 mL of fresh deionized water in a Büchner funnel.

All samples ending in -2 are then placed on a wire mesh and are then conditioned at 21° C.±2° C. and a relative humidity of 50%±2% for 16 hours. After 16 hours, the equilibrated Sample Subsets are weighed (reported in Table 20 above as the Post Wash weight).

The samples are then tested according to the Soil Adsorption Test Method described herein and the data is shown in Table 1 above. From the data, it is clear that these comparative samples are not within the scope of the durably bonded soil adsorbing articles or entangled soil adsorbing articles of the present invention.

### Comparative Examples 3A-3B

### Albaad Baby Wipe Substrates

a. Preparing Monomers Capable of Forming a Soil Adsorbing Polymer

A solution is made as follows: 24 g AAM (available for Sigma Aldrich, Milwaukee, Wis.) and 455 g deionized water are added to a reaction vessel which is sealed with a septa in 45° C. oven for 2 hours.

An Initiator Solution is prepared by adding 0.5044 g of VA-044 (available from Waco Chemicals, Waco, Tex.) to a 5 mL volumetric flask and diluting to 5 mL volume with deionized water.

Then the solution is removed from the oven. The solution is then sparged for 3 minutes with argon. After two minutes of sparging, 1 mL of initiator solution is added to the solution. Then continue heating at 45 C for 16 hours to make the polymer solution.

b. Coating Articles with Monomers Capable of Forming a Soil Adsorbing Polymer

16 Albaad baby wipe substrates are conditioned at 21° C.±2° C. and a relative humidity of 50%±2% for 48 hours. After 48 hours, the equilibrated samples are weighed in subsets of 4 samples as recorded in Table 21 below labeled as initial weight.

A 0.02% solution of the polymer solution is prepared. 3.8 mL of the 0.02% solution of the polymer solution is added to each individual sample. The samples are air dried at 23° C.±2° C. and relative humidity less than 70% for 2 hours on plastic meshes. These samples are divided into 4 subsets of 4 samples each, herein called 1, 2, 3, and 4.

Sample Subsets 1 and 2 are placed in a 60° C. oven for 16 hours. Sample Subsets 3 and 4 are kept at 23° C.±2° C. and relative humidity less than 70% conditions for 16 hours. All of the samples are then conditioned at 21° C.±2° C. and 50%±2% humidity for 16 hours to dry and equilibrate. After 16 hours the weights are recorded in Table 21 below as post treatment weights.

TABLE 21

| Sample | Sample Subsets | Initial Weight | Post treatment | Post Wash |
|---|---|---|---|---|
| 3A | 1 | 2.1050 | 2.1203 | 2.1116 |
| | 2 | 2.0618 | 2.0780 | 2.0686 |
| 3B | 3 | 2.0803 | 2.1062 | 2.0880 |
| | 4 | 2.0894 | 2.1146 | 2.0964 |

Sample Subsets 1 and 3 (listed as After Water Wash in Table 1) are washed with 400 mL of deionized water in a Büchner funnel. The Sample Subsets are then soaked in 400 mL of deionized water for 2 hours followed by washing with 400 mL of fresh deionized water in a Büchner funnel. The soak and wash is then repeated three more times.

Sample Subsets 2 and 4 (listed as After Bicarbonate Wash in Table 1) are washed with 400 mL of 1% aqueous sodium bicarbonate in a Büchner funnel. The Sample Subsets are then soaked in 400 mL of 1% aqueous sodium bicarbonate for 2 hours followed by washing with 400 mL of fresh of 1% aqueous sodium bicarbonate in a Büchner funnel. The soak and wash is then repeated two more times. The Sample Subsets are then soaked in 400 mL of deionized water for 2 hours followed by washing with 400 mL of fresh deionized water in a Büchner funnel.

All samples are then placed on a wire mesh and are then conditioned at 21° C.±2° C. and a relative humidity of 50%±2% for 16 hours. After 16 hours, the equilibrated Sample Subsets are weighed (reported in Table 21 above as the Post Wash weight).

The samples are then tested according to the Soil Adsorption Test Method described herein and the data is shown in Table 1 above. From the data, it is clear that these comparative samples are not within the scope of the durably bonded soil adsorbing articles or entangled soil adsorbing articles of the present invention.

### Non-Limiting Example of Grafting Through for Article-Forming Components (for Example Pulp Fibers)

a. Preparing a Reactive Monomer

1.024 g glycidylmethacrylate (available from Sigma-Aldrich Chemical, Milwaukee, Wis., USA) and 4 L of acetone (available from Sigma-Aldrich Chemical, Milwaukee, Wis., USA) are combined, herein called GMA solution.

b. Preparing Monomers Capable of Forming a Soil Adsorbing Polymer

792.09 g acrylamide (available from Sigma-Aldrich Chemical, Milwaukee, Wis., USA), 11.98 g [3-(methacryloylamino)propyl]trimethyl ammonium chloride 50% aqueous solution (available from Sigma-Aldrich Chemical, Milwaukee, Wis., USA), 2.00 g acrylic acid (available from Sigma-Aldrich Chemical, Milwaukee, Wis., USA) and 794.05 g deionized water are placed into a separate container herein called the monomer solution.

c. Preparing Initiator Solution

10 g of 2,2′azobis(2-amidinopropane)di-hydro chloride (available from Sigma-Aldrich Chemical, Milwaukee, Wis., USA) and 100 mL of deionized water are placed into a separate container herein called the Initiator Solution.

d. Durably Bonding Soil Adsorbing Polymer to Article-Forming Components (i.e., Pulp)

Approximately 310 grams of Northern Softwood Kraft pulp (available from Weyerhaeuser Canada, Alberta, Canada) are conditioned at 21° C.±2° C. and 50%±2% humidity for 2 hours. The sample is weighed and a mass of 306.08 grams is obtained.

The pulp is added to the GMA solution and allowed to stand in the solution for approximately 5 minutes and then the excess fluid is decanted and a mass of the saturated pulp is obtained. The mass is 378.06 grams. The sample is placed on a screen and allowed to air dry for 16 hours. The sample is then placed in a polypropylene bag and then placed in a 50° C. oven for 3.5 hours.

5402.4 grams water and 345.6 grams of monomer solution are added to a bucket and the bucket and contents are heated to 50° C. The GMA treated pulp is then added to the diluted monomer solution. The solution is purged with argon at the rate of 5 mL/sec for 4 minute. During the 3rd minute of purging, 12 mL of the initiator solution is added to the bucket. The solution is capped after the argon purge and heating is maintained at 50° C. for 16 hours.

After 16 hours, the contents of the bucket are poured into a filter funnel and the liquid portion is discarded. The solids are rinsed with 2 gallons of water. The pulp is placed into a 2 gallon container with 800 mL of a 1% w/v sodium bicarbonate solution. The samples are allowed to soak in this solution for 2 hours and filtered and then rinsed with fresh 1% sodium bicarbonate solution in a Büchner funnel. The soak and rinse are repeated twice more. The final soak and rinse uses deionized water. After the final rinse step, the pulp is conditioned at 21° C.±2° C. and 50%±2% humidity for 48 hours to dry and equilibrate. Sample mass is then obtained 297.29 grams.

### Soil

The soil adsorbed by the articles of the present invention may include various consumer soils, such as household soils. Non-limiting examples of such as dust, pet dandruff, dirt including clay, vacuum cleaner soil, grime, greasy soils including dirt and films on mirrors and/or glass surfaces such as windows. The soil may also comprise allergens that may be associated with the consumer soils.

### Test Methods

Unless otherwise specified, all tests described herein including those described under the Definitions section and the following test methods are conducted on samples that have been conditioned in a conditioned room at a temperature of 23° C.±2° C. and a relative humidity of 50%±2% for a minimum of 2 hours prior to the test. The samples tested are “usable units.” “Usable units” as used herein means sheets, flats from roll stock, pre-converted flats, sheet, and/or single or multi-compartment products. Do not test samples that have defects such as wrinkles, tears, holes, and like. Samples conditioned as described herein are considered dry samples (such as “dry filaments”) for testing purposes. All instruments are calibrated according to manufacturer's specifications.

### Basis Weight Test Method

Basis weight of an article is measured on stacks of twelve usable units of the article using a top loading analytical balance with a resolution of ±0.001 g. The balance is protected from air drafts and other disturbances using a draft shield. A precision cutting die, measuring 3.500 in ±0.0035 in by 3.500 in ±0.0035 in is used to prepare all samples.

With a precision cutting die, cut the samples into squares. Combine the cut squares to form a stack twelve samples thick. Measure the mass of the sample stack and record the result to the nearest 0.001 g.

The Basis Weight is calculated in lbs/3000 ft² or g/m² as follows:

Basis Weight=(Mass of stack)/[(Area of 1 square in stack)×(No. of squares in stack)]

For example,

Basis Weight (lbs/3000 ft²)=[[Mass of stack (g)/453.6 (g/lbs)]/[12.25 (in²)/144 (in²/ft²)×12]]×3000

or,

Basis Weight (g/m²)=Mass of stack (g)/[79.032 (cm²)/10,000 (cm²/m²)×12]

Report result to the nearest 0.1 lbs/3000 ft² or 0.1 g/m². Sample dimensions can be changed or varied using a similar precision cutter as mentioned above, so as at least 100 square inches of sample area in stack.

### Durably Bonded Test Method

To determine if a soil adsorbing polymer associated with an article is a durably bonded soil adsorbing polymer, an article, such as a substrate (or article-forming components) comprising a soil adsorbing polymer is, at a bare minimum, soaked in a sufficient amount of an aqueous sodium bicarbonate solution (1% wt by volume sodium bicarbonate in deionized or reverse osmosis water) (enough to completely saturate and submerge the article (article-forming component) under at least 1 inch of the solution) for 2 hours, remove from the sodium bicarbonate solution and with a fresh 1% wt by volume aqueous sodium bicarbonate solution of ½ the volume of the soak rinse through the article (article-forming component) on a filter. Repeat the soak and rinse steps with fresh sodium bicarbonate solution. Then soak the article (article-forming component) in a sufficient amount (enough to completely saturate and submerge the article (article-forming component) under 1 inch of the solution) of deionized or reverse osmosis water for 2 hours, remove from the water and with a fresh water of ½ the volume of the soak rinse through the article (article-forming component) on a filter. Article (article-forming component) is then allowed to air dry. If the article (article-forming component) exhibits a Soil Adsorption Value of greater than 57 mg as measured according to the Soil Adsorption Test Method, then the soil adsorbing polymer is durably bonded to the article (article-forming component) and the soil adsorbing polymer is a durably bonded soil adsorbing polymer and the article (article-forming component) is a durably bonded soil adsorbing article (article-forming component). It is also considered durably bonded if the soil adsorption value is at least 25% greater than the article (or article-forming components) void of the soil adsorbing polymer.

### Soil Adsorption Test Method

a. Sample Preparation

To determine the average soil adsorption value for a treated article, such as a substrate (or article-forming component) after the article has been subjected to the Durably Bonded Test Method described above, the following method is used. The following method describes in detail how to measure an article that is a substrate, such as a fibrous structure, for example a paper towel, a wipe, a cleaning pad, a fabric such as terry cloth, a cotton pad, sponge, and the like. One of ordinary skill in the art would know to adjust the method according to good scientific principles, to measure the average soil adsorption values for other types of articles.

Rectilinear 3.00 inch×4.00 inch pieces of a substrate to be tested are obtained using a 3 inch×4 inch die cutter resulting in samples having a basis weight of from 19 gsm to 33 gsm for handsheets, less than or equal to 100 gsm for paper towels, paper napkins, wipes, sponges, for the floorsheet removed from mops, and for the cleaning (surface contacting) substrate and/or non-surface contacting substrate of other multilayered cleaning systems, and less than or equal to 150 gsm for predominately cotton samples such as cheesecloth, cotton pads, and clothing (samples outside this range are discarded).

The substrate is labeled with the specimen name using a ball-point pen or equivalent marker. After the substrate has been conditioned in a conditioned room at 21° C.±2° C. and a relative humidity of 50%±2% for a minimum of 2 hours, the substrate is weighed to within ±10 mg (Weight_{Substrate}) while still maintaining the conditioning conditions. The remainder of the work is done in a laboratory at a temperature of 21° C.±2° C. and a relative humidity of less than 70%.

The substrate is folded in half so that the substrate forms a 1.5×4 inch testing strip. An accordion style (paper fan) folding technique is then used to fold the testing strip 5 times to produce a testing strip that contains 6 segments each about % inch in width.

b. Soil Solution Preparation

A centrifuge tube (VWR brand 50 mL superclear ultra high performance freestanding centrifuge tube with flat cap, VWR Catalog #82018-052; or equivalent tube) is labeled with the specimen name and weighed to within ±1 mg (Weight_{Vial+Cap}). Next 0.1784 g±0.0005 g of a model soil (Black Todd Clay available from Empirical Manufacturing Co., 7616 Reinhold Drive, Cincinnati, Ohio 45237-3208) is weighed (Weight_{Added Soil}) and then placed into the centrifuge tube. Deionized or reverse osmosis water, 25.0 mL±0.2 mL, is added slowly to the centrifuge tube using a suitable dispenser. The water is poured carefully into the centrifuge tube to avoid causing a plume of dust from the model soil. If a plume of dust occurs, the centrifuge tube is discarded and a new centrifuge tube is prepared. The centrifuge tube is capped and then re-weighed to within ±1 mg (Weight_{Vial+Cap+Dispersion}).

A Petri dish (VWR sterile Petri dish, Simport plastics, 60 mm×15 mm, 28 mL volume, VWR Catalog #60872-306) is labeled with the substrate name and weighed to within ±1 mg (Weight_{Dish}).

The capped centrifuge tube containing the Black Todd Clay and water is then agitated/shaken to disperse the Black Todd Clay in the water to form a soil suspension. The centrifuge tube is then uncapped permitting the testing strip to be fully immersed into the soil suspension, so that the folds of the testing strip run parallel to the length of the centrifuge tube. The centrifuge tube is then immediately re-capped and shaken in a WS 180° shaker for 60±1 seconds. The WS 180° shaker (Glas-Col #099AWS18012) is set at 50% speed so that it inverts the specimen 160-170° every 1 second.

After shaking, the testing strip is carefully removed over a Petri dish using laboratory tweezers. Care must be taken to ensure that all of the soil suspension is kept either in the original centrifuge tube or corresponding Petri dish. The remaining soil suspension is wrung from the testing strip using a “wringing” motion and collected in the Petri dish (≧85% of the soil suspension should be collected). Once the soil suspension has been removed from the testing strip, the testing strip is discarded. The remaining soil suspension in the centrifuge tube is swirled to re-suspend the Black Todd Clay and then poured into the Petri dish, thereby ensuring that no Black Todd Clay is inadvertently left behind in the centrifuge tube. The Petri dish containing the soil suspension is weighed to within ±1 mg (Weight_{Dish+Effluent}). The Petri dish is then placed into a vented laboratory drying oven at 57° C.±5° C. for a minimum of 16 hours to dry the sample. Once the specimen is dry, the Petri dish is removed from the oven and allowed to cool to 21° C.±2° C. The Petri dish is then re-weighed to within ±1 mg (Weight_{Dish+DriedSoil}).

### Calculations

To calculate the amount of residual Black Todd Clay (Mass_{Residual Soil}) left in the Petri dish, the following equation is used:

Mass_{ResidualSoil}=Weight_{Dish+DriedSoil}−Weight_{Dish}

Residual Black Todd Clay is reported in mg.

To calculate the amount of soil adsorbed (Soil Retained) in the substrate (testing strip), the following calculation is used:

SoilRetained=Weight_{AddedSoil}−Mass_{ResidualSoil}

The amount of soil adsorbed is reported in mg.

To calculate the percent of soil retained (% Soil Retained), the following calculation is used:

$$\% Soil Retained = [ \frac{Soil Retained}{{Weight}_{AddedSoil}} ] * 100 \%$$

The test is performed on four replicates and the average amount of soil adsorbed (also known as the Soil Adsorption Value) and the average percent of soil retained (% Soil Retained_{avg}) are calculated for the substrate.

The percent change between an article void of soil adsorbing polymer and a durably bonded soil adsorbing article, is the ((difference between the Soil Adsorption Value for Durably Bonded Soil Adsorbing Article and Soil Adsorption Value for Article void of Soil Adsorbing Polymer) divided by the Soil Adsorption Value for Article void of Soil Adsorbing Polymer)×100%. This gives the “% Greater than the Article void of Soil Adsorbing Polymer.”

### Water Content Test Method

The water (moisture) content present in an article is measured using the following Water Content Test Method. An article is placed in a conditioned room at a temperature of 23° C.±1.0° C. and a relative humidity of 50%±2% for at least 24 hours prior to testing. Each article has an area of at least 4 square inches, but small enough in size to fit appropriately on the balance weighing plate. Under the temperature and humidity conditions mentioned above, using a balance with at least four decimal places, the weight of the sample is recorded every five minutes until a change of less than 0.5% of previous weight is detected during a 10 minute period. The final weight is recorded as the “equilibrium weight”. Within 10 minutes, the samples are placed into the forced air oven on top of foil for 24 hours at 21° C.±2° C. at a relative humidity of 4%±2% for drying. After the 24 hours of drying, the sample is removed and weighed within 15 seconds. This weight is designated as the “dry weight” of the sample.

The water (moisture) content of the sample is calculated as follows:

$$\% Water in sample = 100 \% \times \frac{( Equilibrium weight of sample - Dry weight of sample )}{Dry weight of sample}$$

The % Water (moisture) in sample for 3 replicates is averaged to give the reported % Water (moisture) in sample. Report results to the nearest 0.1%.

### Charge Density Test Method

The charge density of a polymer, such as a soil adsorption polymer, can be determined by using a Mutek PCD-04 Particle Charge Detector available from BTG, or equivalent instrument. The following guidelines provided by BTG are used.

Start with a 0.1% solution (0.1 g polymer+99.9 g deionized water) (sample). Depending on the titrant consumption increase or decrease polymer content if needed. Solution pH is adjusted prior to final dilution as charge density of many polymers and/or additives is dependent upon solution pH. A pH of 4.5 is used here.

1. Place 20 mL of sample in the PCD measuring cell and insert piston.

2. Put the measuring cell with piston and sample in the PCD, the electrodes are facing the rear. Slide the cell along the guide until it touches the rear.

3. Pull piston upwards and turn it counter-clock-wise to lock the piston in place.

4. Switch on the motor. The streaming potential is shown on the touch panel. Wait 2 minutes until the signal is stable.

5. Use an oppositely charged titrant (for example for a cationic sample having a positive streaming potential: use an anionic titrant). Titrants are available from BTG consisting of 0.001N PVSK or 0.001N PolyDADMAC.

6. An automatic titrator available from BTG is utilized. After selecting the proper titrant, set the titrator to rinse the tubing by dispensing 10 mL insuring that all air bubbles have been purged.

7. Place tubing tip below the surface of the sample and start titration. The automatic titrator is set to stop automatically when the potential reaches 0 mV.

8. Record consumption of titrant, ideally, the consumption of titrant should be 0.2 mL to 10 mL; otherwise decrease or increase polymer content.

9. Repeat titration of a second 20 mL aliquot of the polymer sample.

10. Calculate charge demand (solution) or charge demand (solids);

$$Charge demand ( eq \text{/} L ) = \frac{V titrant used ( L ) \times Conc . of titrant in Normality ( eq \text{/} L )}{Volume of sample titrated ( L )}$$

$$Charge demand ( eq \text{/} g ) = \frac{V titrant used ( L ) \times Conc . of titrant in Normality ( eq \text{/} L )}{Wt . solids of the sample or its active substance ( g )}$$

The charge demand (charge density) of a polymer is reported in meq/g units.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A durably bonded soil adsorbing article comprising a durably bonded soil adsorbing polymer as determined by the Durably Bonded Test Method such that the durably bonded soil adsorbing article exhibits an average soil adsorption value of greater than 57 mg as measured according to the Soil Adsorption Test Method.

2. The article according to claim 1 wherein the article is disposable.

3. The article according to claim 1 wherein the article comprises a nonwoven material.

4. The article according to claim 1 wherein the article comprises a foam structure.

5. The article according to claim 1 wherein the article comprises a sponge.

6. The article according to claim 1 wherein the article comprises a fibrous structure comprising a hydroxyl polymer.

7. The article according to claim 6 wherein the hydroxyl polymer is selected from the group consisting of: polyvinyl alcohol, cellulose, carboxymethylcellulose, chitin, chitosan, starch, starch derivatives, keratin, and mixtures thereof.

8. The article according to claim 1 wherein the article comprises a fibrous structure comprising an amine moiety.

9. The article according to claim 1 wherein the soil adsorbing polymer comprises a polymer comprising a monomeric unit selected from the group consisting of: acrylamide monomeric units or derivatives thereof, carboxylic acid-containing monomeric units, quaternary ammonium-containing monomeric units, other free-radically polymerizable monomeric units, and mixtures thereof.

10. The article according to claim 1 wherein the soil adsorbing polymer comprises polyethyleneimine.

11. The article according to claim 1 wherein the soil adsorbing polymer comprises polyacrylamide.

12. The article according to claim 1 wherein the article is selected from the group consisting of: towels, dryer sheets, filter media, wipes, sponges, mops, cleaning implements, door mats, car mats, disposable cloths, laundry sheets, paper towels, absorbent cores, scrubbing pads, brushes, facial tissue, dusters, and French press.

13. A durably bonded soil adsorbing article comprising a soil adsorbing polymer wherein the article exhibits an average soil adsorption value of at least 25% greater than the article void of the soil adsorbing polymer as measured according to the Soil Adsorption Test Method.

14. The article according to claim 13 wherein the article comprises a fibrous structure comprising a hydroxyl polymer.

15. The article according to claim 14 wherein the hydroxyl polymer is selected from the group consisting of: polyvinyl alcohol, cellulose, carboxymethylcellulose, chitin, chitosan, starch, starch derivatives, keratin, and mixtures thereof.

16. The article according to claim 13 wherein the soil adsorbing polymer comprises polyacrylamide.

17. A method for treating a surface, the method comprising the step of contacting a surface to be treated with a durably bonded soil adsorbing article according to claim 1.

18. A method for treating a fluid, the method comprising the step of contacting the fluid with a durably bonded soil adsorbing article according to claim 1.

19. A method for treating a surface, the method comprising the step of contacting a surface to be treated with a durably bonded soil adsorbing article according to claim 13.

20. A method for treating a fluid, the method comprising the step of contacting the fluid with a durably bonded soil adsorbing article according to claim 13.
